(19) United States
(12) Patent Application Publication
(10) Pub. No.: US 2020/0359649 A1
(43) Pub. Date: Nov. 19, 2020

(54) METHOD FOR PRODUCING PUREE OR PASTE OF INGREDIENT, METHOD FOR PRODUCING ICE CONFECTION USING PUREE OR PASTE OF INGREDIENT, METHOD FOR PRODUCING DRINK IN AIRTIGHT CONTAINER, AND SYSTEM FOR PRODUCING THESE

(71) Applicant: MASHUP CO., LTD., Tokyo (JP)

(72) Inventor: Kinya MAENO, Tokyo (JP)

(21) Appl. No.: 16/638,448

(22) PCT Filed: Aug. 10, 2018
(86) PCT No.: PCT/JP2018/030160

§ 371 Date: Feb. 11, 2020

(30) Foreign Application Priority Data
Aug. 11, 2017 (JP) 2017-156264
Dec. 11, 2017 (JP) 2017-236860

(51) Int. Cl. A23G 9/42; A23L 19/00; A23L 25/00; A23L 11/00; A23G 9/08; A23G 9/04; B65D 75/00; B65D 75/58; G06Q 50/12

(52) U.S. Cl. CPC A23G 9/42; A23L 19/09; A23L 25/30; A23L 11/05; A23V 2002/00; A23G 9/045; B65D 75/008; B65D 75/5883; G06Q 50/12; A23G 9/083

(57) ABSTRACT

Provided are a method and a system for producing puree or paste that is less likely to separate or drip or for producing an ice confection, without compromising the flavors and colors of the ingredients. The producing method according to an embodiment of the present invention includes the following steps: (1) cutting fruit or a vegetable to have a certain size, (2) performing heat sterilization for a certain period of time in a low oxygen state in a superheated steam atmosphere at a certain temperature, and (3) processing the fruit or the vegetable into a puree or paste form using any one of a planetary centrifugal mixer, a millstone grinder, and a rotary cutter mixer, depending on the type of the fruit or the vegetable or the finished state of the puree or paste. Adding a stabilizer such as kudzu starch to the puree or paste thus produced to make an ice confection can provide an ice confection having unique texture, almost without dripping even when being melted.

### FIELD

Embodiments of the present invention relate to a method for producing puree or paste of an ingredient, a method for producing an ice confection using the puree or paste of the ingredient, a method for producing a drink in an airtight container, and a system for producing these.

### BACKGROUND

Conventionally, a typical method for producing an ice confection requires multiple sterilization steps prior to a refrigerating step. Patent Literature 1 discloses a method for producing an ice confection including adding fruit juice to a material mix serving as the material of an ice confection and making an adjustment, heating the material mix for sterilization, and bringing the mixture into a refrigerating step after the heat sterilization. When fruit juice processed in another factory is used, the fruit juice undergoes the first heat sterilization in its processing stage and the second heat sterilization prior to the refrigerating step. Performing heat sterilization for multiple times requires an increased number of production steps and involves an increased time and cost accordingly, which may negatively affect the flavor of the material fruit.

Some methods for producing puree of a material have been developed so as not to negatively affect the flavor of fruit. Patent Literature 2 discloses a method for producing ice cream including grinding a vegetable with a millstone so as not to lose its smell, taste, and the like in producing vegetable puree. In the production steps for vegetable puree, grinding is followed by heat sterilization before storage. Then, the production steps for ice cream also involve heat sterilization in a pastelizer. This means that, although a millstone is used so as not to lose flavors in producing puree, undergoing two heat sterilization steps may negatively affect the flavors and colors of vegetables.

Patent Literature 3 discloses a method for producing puree of fruit or vegetables including cutting fruit or vegetables to suitably sized pieces, maintaining the pieces for about 30 seconds to 240 seconds in a superheated steam atmosphere heated to 280° C. to 350° C. for sterilization, and then crushing the pieces with a strainer mill to produce puree. The strainer mill includes a strainer arranged in a case that rotates and revolves. The pieces of fruit or vegetables after sterilization are placed in the strainer in the case, and the case rotates and revolves to pass through the strainer and crushes the pieces so as to process them into paste or puree. Sterilization using superheated steam can improve the coloration of fruit and vegetables. If necessary, the impasted or pureed fruit and vegetables may be kept in a superheated steam atmosphere heated to 280° C. to 350° C. for about 30 seconds to 240 seconds to perform secondary sterilization.

Conventionally, producing and selling juices, smoothies, frappes, or the like to individual customers commonly include placing frozen ingredients such as fruit in a mixer with water, or placing fresh ingredients such as fruit in a mixer with ice, water, or the like, crushing them in the mixer to produce cold juices, smoothies, frappes, or the like, and providing the produced juices, smoothies, frappes, or the like by filling them in cups. In most of such production of juice for individual customers, predetermined amounts of ingredients, water, ice, or the like are generally added before provision. The type and amount of sweetener, the amount of pulp when added, the selection of ingredients and the setting of mixing ratio for mixed juice, the setting of juice concentration, or the like are hardly selected flexibly according to customers' orders due to necessary time and effort.

Meanwhile, Patent Literature 4 discloses a fresh shot sales system for food and drink, which prepares various juices, smoothies, frappes, and the like as requested by customers. As illustrated in FIG. 20, such a sales system 200 includes a plurality of dedicated cups C each containing a plurality of cartridges 202 in each of which a predetermined material is pre-packed, and a mixing machine B that automatically stirs and mixes the material and liquid in the dedicated cup C loaded into the mixing machine B. When a customer selects a desired product from a plurality of dedicated cups C displayed on a shelf 203 or from a displayed menu board 204 and places an order, a salesperson takes out a certain dedicated cup C in accordance with the customer's order. The sales person loads the certain dedicated cup C into the mixing machine B, produces the customer's desired product at a counter 201 in front of the customer, and then delivers the desired product in exchange for a predetermined price.

Patent Literature 5 describes ice confections as an example of food. The term “foodstuff” referring to a material or composition used as an ingredient in preparing food includes grains, cereals, starchy fruits and vegetables. Suitable examples include flours prepared from wheat, rice, corn, oat, potato, sorghum, millet, rye, triticale, and barley. Other flours include semolina flour, Atta flour, buckwheat flour, tapioca flour, brown rice flour, glutinous rice flour, noodle flour, pasta flour, chestnut flour, various nut flours, chickpea flour, bean flour, pea flour, spelt flour, and potato starch flour. Foodstuffs which can be modified further include cornstarch, instant mashed potatoes, prepared mixes for baked goods including bread dough, cake mixes, pancake mixes, and so forth. Additional foodstuffs that can be modified according to the invention include preparations of bulgur, quinoa, triticale, parsnip, plantain, potato, pumpkin, acorn squash, butternut squash, summer squash, green peas, corn, yams, taro, cassava, and breadfruit. Preferred foodstuffs for use in the invention are carbohydrate-based foodstuffs.

One of the aspects of ice confections is shaved ice. The shaved ice disclosed in Patent Literature 6 is made by cutting an originally flavored ice block with an ice shaver, and thus fruit taste can be uniformly dispersed throughout the shaved ice.

### CITATION LIST

### Patent Literature

[Patent Literature 1] Japanese Patent Application Publication No. 2013-162758
[Patent Literature 2] Japanese Patent Application Publication No. H8-308503
[Patent Literature 3] Japanese Patent Application Publication No. 2007-282523
[Patent Literature 4] Japanese Patent Application Publication No. 2002-080097
[Patent Literature 5] Japanese Translation of PCT International Application Publication No. 2012-509069
[Patent Literature 6] Japanese Patent Application Publication No. 2017-190889

### Non-Patent Literature

[Non-Patent Literature 1] goo health care <URL: https://health.goo.ne.jp/column/healthy/h002/0085.html>
[Non-Patent Literature 2] Healing forest for menopausal girls <URL: http://konenki-iyashi.com/category17/entry302.html>
[Non-Patent Literature 3] Wikipedia “Ayurveda” <URL: https://ja.wikipedia.org/wiki/% E3%82% A2% E3%83% BC % E3%83% A6% E 3% 83% AB % E3%83% B4% E3%82% A7% E3%83% BC % E3%83%80>

### SUMMARY

### Technical Problem

In the method for producing an ice confection disclosed in Patent Literature 1 described above, when fruit juice processed in another factory is used, the fruit juice undergoes the first heat sterilization in its processing stage and the second heat sterilization prior to the refrigerating step. Thus, there is a problem in that performing heat sterilization for multiple times requires an increased number of production steps and involves an increased time and cost accordingly, which may negatively affect the flavor of the material fruit.

In the method for producing ice cream disclosed in Patent Literature 2 described above, although a millstone is used so as not to lose flavors in producing puree, there is a problem in that undergoing two heat sterilization steps may negatively affect the flavors and colors of vegetables.

In the method for producing puree disclosed in Patent Literature 3 described above, although sterilization using superheated steam can be expected to improve the coloration of fruit and vegetables, there is a problem in that the sterilization step using superheated steam may be performed twice, or holding sterilization may be performed separately. In addition, producing ice confections in another factory requires another heat sterilization step using a pasteurizer or the like, involving more production processes and an increased time and cost accordingly, which may negatively affect the flavor of the material fruit and vegetables.

Furthermore, with the sales system disclosed in Patent Literature 4 described above, simply preparing a plurality of dedicated cups in advance enables production and delivery of a product selected from a variety of products according to a customer's order in front of the customer. However, there is an issue in that, since predetermined materials and liquids need to be packed in dedicated cups C in advance, meeting all customer's requests, such as changing the sweetener to a specific component and changing the amount thereof, requires many dedicated cups C to be prepared. In addition, supplying the juices, smoothies, frappes, and the like filled in an airtight container such as an aluminum pouch, for example, in order to allow them to be stored for a certain period of time requires heat sterilization, and thus they cannot be delivered immediately.

On the other hand, a production system for mass-produced juice or the like of a food manufacturer or other entities can produce a large amount of heat-sterilized juice filled in an airtight container; however, such a system provides uniform products and has difficulty in providing a product properly meeting a customer's detailed request. In addition, such a system does not consider provision of a drink in an airtight container in a cooled state or frozen state in accordance with a customer's request.

Furthermore, no patent literature cited above discloses personal taste preference or a viewpoint of actively acquiring nutrient components that are often insufficient for modern people. The importance of a well-balanced diet has been recognized from both points of view of Eastern medicine and Western medicine as well as a point of view of preventive medicine. In recent years, dietary fiber has attracted attention as the sixth nutrient, and phytochemicals, a component of plant foods, which have not been recognized as a nutrient until now, have attracted attention as the seventh nutrient.

Patent Literature 5 lists examples of foods and examples of ingredients for preparing foods. However, the examples do not describe any suitable stabilizer for ice confections and cannot be used as stabilizers for ice confections as they are. The definition of stabilizer for an ice confection herein is not specifically limited, and it serves as a “binder” to make an ice confection easier to keep together. It also contributes to the texture of an ice confection (e.g., thickened feeling, chewy feeling, gooey feeling, dry feeling, gummy feeling, smooth feeling, etc.) and the melt-resistance of an ice confection (the property of being difficult to drip at room temperature, the property of retaining the shape, etc.).

In Patent Literature 6, there is a problem in that preparing an ice block takes time and effort because the ice block needs to be frozen and produced to the size of an ice shaver by using a dedicated container through a plurality of procedures. In addition, the taste of a dedicated ice block is determined by the fruits, vegetables, puree, and juice selected when the ice block is frozen, and it cannot be adjusted. That is, an ingredient or a taste cannot be selected in accordance with personal taste preferences such as preference for sweetness or sourness, and required nutrients. Also, the texture cannot be changed.

In response to the above issues involved in conventional methods for producing an ice confection using puree or paste of ingredients, the inventor of the present invention has performed various experiments. As a result, the inventor has completed embodiments of the present invention through the following advantages he has found. Specifically, by improving steps for producing puree or paste, such as setting appropriate superheating conditions with superheated steam before ingredients are put into a mill, any other sterilization step can be omitted, and puree or paste that is less likely to separate can be produced without compromising the flavors and colors of the ingredients. Furthermore, by improving recipes or steps for producing an ice confection for which this puree or paste is suitable, an ice confection that is less likely to drip (i.e., less likely to melt and drip at room temperature) can be produced without compromising the flavors and colors of the ingredients. In addition, the production steps can be simplified, and when provided as a drink in an airtight container, a customer's detailed requests such as a cooled state or frozen state can be fulfilled as appropriate.

Specifically, a first object of embodiments of the present invention is to provide a method and a system for producing puree or paste that can produce puree or paste that is less likely to separate without compromising the flavor and color of ingredients, and that can omit any other sterilization step.

A second object of embodiments of the present invention is to provide, by using the puree or paste of the ingredients described above, a method and a system for producing an ice confection that has good texture without compromising the flavors and colors of the ingredients, and that is less likely to drip, in which the production steps can be simplified.

A third object of embodiments of the present invention is to provide a drink in an airtight container made by using the puree or paste of the ingredients described above, with which a customer's detailed requests such as a cooled state or frozen state of the drink in an airtight container can be fulfilled as appropriate, and requests from most customers can be fulfilled as appropriate, and to provide a method and a system for producing the drink in an airtight container.

### Solution to Problem

A method for producing puree or paste of an ingredient according to a first aspect of the present invention includes steps (1) to (3):

(1) cutting an ingredient into a certain size when the ingredient is at least as large as a size predetermined for the ingredient;
(2) performing heat sterilization for a certain period of time in a low oxygen state in a superheated steam atmosphere at a certain temperature; and
(3) processing the ingredient into a puree or paste form using any one of a planetary centrifugal mixer, a millstone grinder, and a rotary cutter mixer, depending on a type of the ingredient or a finished state of the puree or paste.

A method for producing an ice confection according to a second aspect of the present invention uses at least one type of drink selected from a drink made of the puree or paste of the ingredient produced by the method for producing puree or paste of an ingredient according to the first aspect and a drink containing a flavor material, and includes steps (4) to (6):

(4) preparing a second aqueous solution by adding a stabilizer to the selected drink;
(5) injecting the second aqueous solution into a mold having a certain shape; and
(6) refrigerating and freezing the second aqueous solution injected into the mold by circulating a refrigerant around the mold.

A method for producing a drink in an airtight container on demand by a customer's order according to a third aspect of the present invention uses at least one type of drink selected from a drink made of the puree or paste of the ingredient produced by the method for producing puree or paste of an ingredient according to the first aspect and a drink containing a flavor material, and includes steps (1b) to (4b):

(1b) preparing drinks, purees, or pastes of various types of ingredients in advance;

(2b) selecting at least one of the drinks, purees, or pastes of the ingredients that fulfills the customer's order;

(3b) filling and sealing the drink, puree, or paste of the selected ingredient in an airtight container; and

(4b) cooling the airtight container filled with the drink, puree, or paste of the ingredient in a refrigerator maintained at a certain temperature for a certain period of time such that the drink, puree, or paste of the ingredient becomes a state that fulfills the customer's order.

### Advantageous Effects of Invention

The method for producing puree or paste of an ingredient according to the first aspect of the present invention can produce puree or paste that is less likely to separate without compromising the flavor and color of the ingredient, and that can omit any other sterilization step. In the step of performing heat sterilization for a certain period of time in a low oxygen state in a superheated steam atmosphere at a certain temperature, the ingredient can be prevented from oxidizing because it is in the low oxygen state, and it is less likely to be charred in this environment free of incineration. Furthermore, the superheated steam has a larger quantity of heat than that of heated air and is emission-free and highly safety. In the step of processing the ingredient into a puree or paste form, the ingredient can be processed depending on the type of the ingredient or the finished state of the puree or paste. With the planetary centrifugal mixer, two types of centrifugal forces, rotation and revolution, work on the container with a strainer interactively, whereby convection occurs in the ingredient, getting rid of bubbles therein. When sifted through the strainer, the ingredient including fibers can be separated from hard cores. With the millstone grinder, the ingredient ground with the millstone is less likely to lose its taste and smell, and hard ingredients can be processed as well. The rotary cutter mixer is suitable for leaf vegetables, for example.

The method for producing an ice confection according to the second aspect of the present invention can produce, by using the puree or paste of the ingredient described above, an ice confection that is less likely to drip without compromising the flavor and color of the ingredient, and the production steps can be simplified. For example, the step of preparing the first and the second aqueous solutions can be simplified. When a step of putting air into the ice confection is included, the overrun of the ice confection can be controlled between 60% and 300%.

The method for producing an ice confection according to the third aspect of the present invention can provide a drink in an airtight container with which a customer's detailed requests such as a cooled state or frozen state of the drink in an airtight container can be fulfilled as appropriate and requests from most customers can be fulfilled as appropriate through cooling for a certain period of time in a refrigerator maintained at a certain temperature on demand by a customer's order such that the drink, puree, or paste of the ingredient becomes a state that fulfills the customer's order, and can provide a method and a system for producing the drink in an airtight container.

### BRIEF DESCRIPTION OF DRAWINGS

FIG. 1 is a process chart according to a first embodiment.

FIG. 2 is a conceptual diagram of a planetary centrifugal mixer used in the first embodiment.

FIG. 3 is a process chart according to a second embodiment.

FIG. 4 is a conceptual diagram of a refrigerator used in the second embodiment.

FIG. 5 is a process chart according to a fifth embodiment.

FIG. 6 illustrates example containers mimicing the shapes of ingredients according to the fifth embodiment.

FIG. 7 is a process chart illustrating steps for producing a packed drink according to a seventh embodiment.

FIG. 8 is a block diagram schematically illustrating a packed drink producing system according to the seventh embodiment.

FIG. 9 is a perspective view of an example packed drink produced.

FIG. 10 is a conceptual diagram of a refrigerator.

FIG. 11 is a process chart illustrating steps for producing a packed drink according to an eighth embodiment.

FIG. 12 is a perspective view of another example packed drink according to the eighth embodiment.

FIG. 13 is a process chart according to a ninth embodiment.

FIG. 14 is a system configuration diagram according to a tenth embodiment.

FIG. 15 illustrates an example cube form or rock form ice confection according to the tenth embodiment.

FIG. 16 illustrates an example rechargeable cordless hand-held ice shaver according to the tenth embodiment.

FIG. 17 illustrates how a cube form or rock form ice confection appears while it is being shaved using the ice shaver illustrated in FIG. 16.

FIG. 18 illustrates an example shaved ice confection.

FIG. 19 is a block diagram of a system for producing a shaved ice confection according to an eleventh embodiment.

FIG. 20A is a perspective view illustrating a conventional fresh shot sales system, and FIG. 20B is a side view illustrating how dedicated cups are displayed.

### DESCRIPTION OF EMBODIMENTS

The following describes a method and system for producing puree or paste of an ingredient and a method and a system for producing an ice confection according to embodiments of the present invention in detail with reference to the accompanying drawings. However, the following embodiments are intended to illustrate a method and a system for producing puree or paste of an ingredient and a method and a system for producing an ice confection to embody the technical ideas of the present invention, and it should be appreciated that embodiments of the present invention are not limited to these and are equally applicable to any other embodiments included in the scope of the appended claims.

### First Embodiment

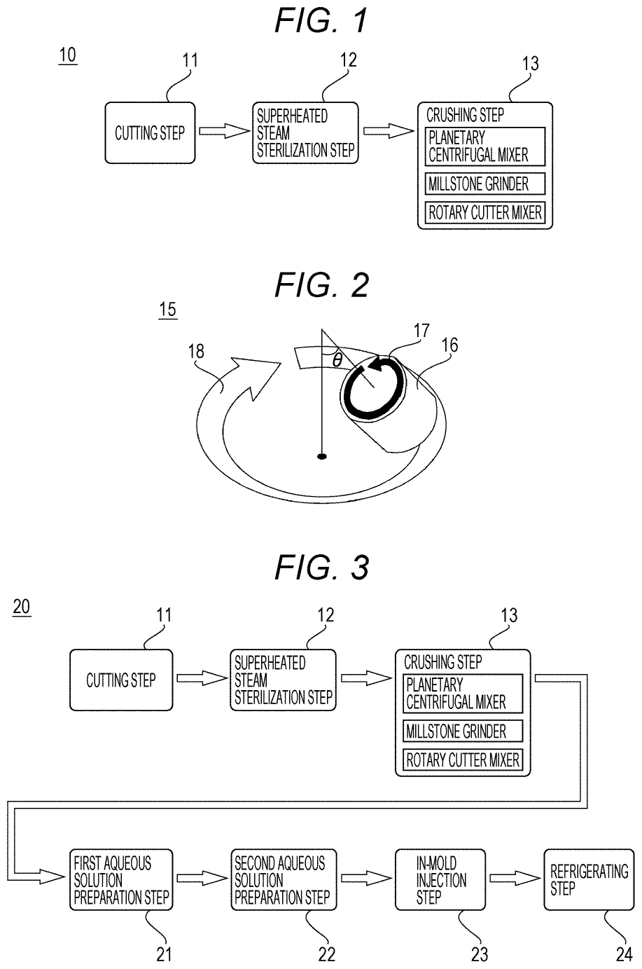

With reference to FIG. 1 and FIG. 2, a method and a system for producing puree or paste of an ingredient according to a first embodiment will be described.

FIG. 1 is a process chart according to the first embodiment. Production steps 10 for puree or paste of an ingredient according to the first embodiment include a cutting step 11, a superheated steam sterilization step 12, and a crushing step 13 in this order. Ingredients to be processed are not limited to particular types, and examples thereof include fruits, vegetables, beans, nuts and seeds, and grains. For examples, fruits include strawberry and other berries and citrus, vegetables include tomato, carrot, and leaf vegetables, beans include green soybean and soybean, nuts and seeds include nuts such as pistachio and hazelnut, and grains include rice and wheat. A wide range of ingredients can be processed as the ingredient used herein.

In the cutting step 11, a food slicer is used to cut the ingredient. For example, when the ingredient is cut using a food slicer having a plurality of rotary round blades that pull in the ingredient to cut it (for example, F-V2/V3/V4/V6/V8 series manufactured by Dremax (registered trademark)), the ingredient can be cut into a certain size under no extra stress, whereby the ingredient can be prevented from having compromised flavor or color and can maintain freshness. Depending on the type of the ingredients, the cutting step 11 can be omitted. For example, rice, wheat, and the like do not need cutting. Whether cutting is needed is determined based on whether the ingredient is at least as large as a size predetermined for each ingredient. Cutting the ingredient may be performed manually using a kitchen knife.

In the superheated steam sterilization step 12, using a superheated steam sterilization device, the ingredient is heated and sterilized for a certain period of time in a low oxygen state (lower than the oxygen level in the atmosphere) in a superheated steam atmosphere at a certain temperature. Saturated steam functions to keep the oxygen level low, for example, at an oxygen-free level (0%). In addition, by keeping the level around 0.1% to 0.2%, the ingredient can be prevented from oxidizing even when heated, which can prevent the ingredient to have compromised flavor or color. Furthermore, the superheated steam has a larger quantity of heat than that of heated air and is emission-free and highly safety. In the superheated steam sterilization step 12, at the same time of sterilization of the ingredient, the ingredient is processed to be softer prior to the crushing step. The superheated steam sterilization step 12 also serves as blanching. A conventional blanching process typically involves boiling or grilling, the former may result in color loss and the latter may result in scorch. Using the superheated steam sterilization device also serving as a device for blanching can prevent the ingredient to have compromised flavor or color, and water-soluble nutrients are highly likely to remain.

As the superheated steam sterilization device, a device is used that heats steam delivered from a steam generator to generate superheated steam, and injects the superheated steam from above and below the ingredient. The temperature and heating duration of the superheated steam in the superheated steam sterilization step 12 are set as appropriate depending on the type and state of the ingredient and the completed state of the puree or paste. The temperature of the superheated steam ranges, for example, from about 100° C. to about 400° C., and can be preferably from about 100° C. to about 280° C. The range of inverse point temperature, having a higher drying rate than that of the air, is from 170° C. to 280° C., in which the critical point is reached at 280° C. For example, the heating duration is set as appropriate within a range of about 1 minute to about 60 minutes depending on the type and state of the ingredient and the finished state of the puree or paste, and can be preferably from about 4 minutes to about 50 minutes. While the superheated steam sterilization device employs a structure to emit injected superheated steam outside, an alternative structure can circulate injected superheated steam.

In the crushing step 13, depending on the type and state of the ingredient and the finished state of the puree or paste, the ingredient is processed into a puree form or paste form with a planetary centrifugal mixer, a millstone grinder, or a rotary cutter mixer. Any one of the planetary centrifugal mixer, the millstone grinder, and the rotary cutter mixer is selected as crushing means as appropriate depending on the type of the ingredient or the finished state of the puree or paste. Furthermore, since settings for the means selected are adjustable as appropriate, a desired finished state of the puree or paste can be achieved irrespective of the type of the ingredient. Examples of the elements to adjust settings for the crushing means include the speed and duration of rotation and revolution, the shape of a strainer, the diameter of holes in the strainer, and the like for the planetary centrifugal mixer, the rotational rate and duration of a millstone, the granularity of crushing, and the like for the millstone grinder, and the rotational rate and duration of rotary blades, the type of the rotary blades, and the like for the rotary cutter mixer.

The following describes crushing processing using the planetary centrifugal mixer. FIG. 2 is a conceptual diagram of a planetary centrifugal mixer 15 used in the first embodiment. The planetary centrifugal mixer 15 is provided with one or more, for example, two rotary members 16 that have a substantially bottomed cylindrical shape and rotate and revolve. Each of the rotary members 16 rotates in a spin direction 17 and revolves in a revolution direction 18. An angle θ formed by the axial center of the rotary member 16 and the central axis of revolution can be any value within a range from 0 degrees to 90 degrees, for example, within a range from about 30 degrees to about 60 degrees, and is set at 45 degrees as an example. In other words, the opening of the rotary member 16 is tilted by 45 degrees with respect to the revolution axis. In the example in FIG. 2, the rotary member 16 revolves in the revolution direction 18, i.e., clockwise, and the rotary member 16 rotates in the spin direction 17, i.e., counterclockwise. This relation of the rotational directions may be reversed, so that the revolution direction 18 can be counterclockwise and the spin direction 17 can be clockwise. Alternatively, both the spin direction 17 and the revolution direction 18 may be clockwise, or both the spin direction 17 and the revolution direction 18 may be counterclockwise.

Although not illustrated in FIG. 2, a rotary container having a substantially bottomed cylindrical shape is fitted inside the rotary member 16 from the opening side of the rotary member 16 so as to rotate integrally with the rotary member 16. To the opening of the rotary container, a retainer having a shape recessed to open a space toward the opening of the rotary member and having a plurality of holes is fixed with a lid member or other fixing member, whereby the rotary container and the retainer rotate integrally with the rotary member 16. The ingredient to be processed is put in the recess of the retainer. With the centrifugal forces working on the rotary container due to the rotation and revolution of the rotary member 16, the ingredient is sifted through the holes in the retainer and is thus crushed. The crushed ingredient piles up in the rotary container. In this process, the two types of centrifugal forces, rotation and revolution, work interactively, whereby convection occurs in the ingredient, releasing bubbles therein. While being deaired, the ingredient is pushed out through the holes in the strainer by the centrifugal forces. As a result, while the puree or paste retains fibers therein, the ingredient can be separated from hard cores, and the ingredient can be prevented from having compromised flavor or color.

The retainer has a plurality of holes of about 0.3 mm to about 2.0 mm, and is provided in a plurality of types with different shapes and hole diameters. For example, some retainers have irregularities on their surfaces, whereas others do not. While the rotary member 16 is set such that it revolves once per single rotation, this setting may be adjusted as appropriate. The rotational rate can be adjusted as appropriate within a range of about 0 to about 1500 per minute. For example, if the rotational rate is set to 1000 per minute, the rotary member 16 rotates 1000 times per minute and revolve 1000 times per minute. The rotational duration can be, for example, about 20 seconds to about 120 seconds. The type of the retainer and the rotational rate and duration of the rotary member 16 are set as appropriate depending on the type and state of the ingredient and the completed state of the puree or paste, and are not limited to the foregoing. Crushing processing using the planetary centrifugal mixer is suitable for fruit, for example, berries and citrus in particular.

Crushing processing using the millstone grinder is described. The millstone grinder is, for example, an electric millstone, a specific example of which is Supermasscolloider manufactured by Masuko Sangyo Co., Ltd. This is a superfine grinder equipped with a millstone composed of two, upper and lower non-porous grinding stones with an adjustable space therebetween. With the millstone grinder, the ingredient ground with the millstone is less likely to lose its taste and smell, and hard ingredients can be processed as well. For example, the rotational rate and duration of the millstone, the space between the grinding stones, the granularity of crushing, and the like are set as appropriate depending on the type and state of the ingredient and the completed state of the puree or paste. Crushing processing using the millstone grinder is suitable, for example, for peas, grain such as rice, nuts and seeds (such as pistachio and hazel nuts, for example). For processing strawberries, for example, using the planetary centrifugal mixer can process the ingredient into a puree form retaining fibers therein, whereas using the millstone grinder can process the ingredient into a smooth paste form.

Crushing processing using the rotary cutter mixer is described. The rotary cutter mixer is a crusher that crushes ingredients as rotary blades rotate, a specific example of which is Vita-Mix manufactured by Vita-Mix Corporation. The rotational rate and duration of the rotary blades, the type of the rotary blades, and the like are set as appropriate depending on the type and state of the ingredient and the completed state of the puree or paste. Crushing processing using the rotary cutter mixer is suitable for leaf vegetables in particular.

Post-processing after the puree or paste of the ingredient is obtained through the cutting step 11, the superheated steam sterilization step 12, and the crushing step 13 is described. In producing an ice confection using puree or paste of an ingredient in an integrated manner, the puree or paste of the ingredient as is is put into a post-process as described later in the second embodiment below. By contrast, in shipping or storing puree or paste of an ingredient as is, a fixed amount of the puree or paste of the ingredient is filled in a storage package by a filling machine, and then frozen in a refrigerator. The refrigerating temperature, which needs to retain the ingredient in its frozen state, is preferably −30° C. or lower, for example. The puree or paste of the ingredient is shipped or stored in its frozen state. Furthermore, the puree or paste of the ingredient is tested with metal sensors to see if there is no metallic piece included during the processing.

### Second Embodiment

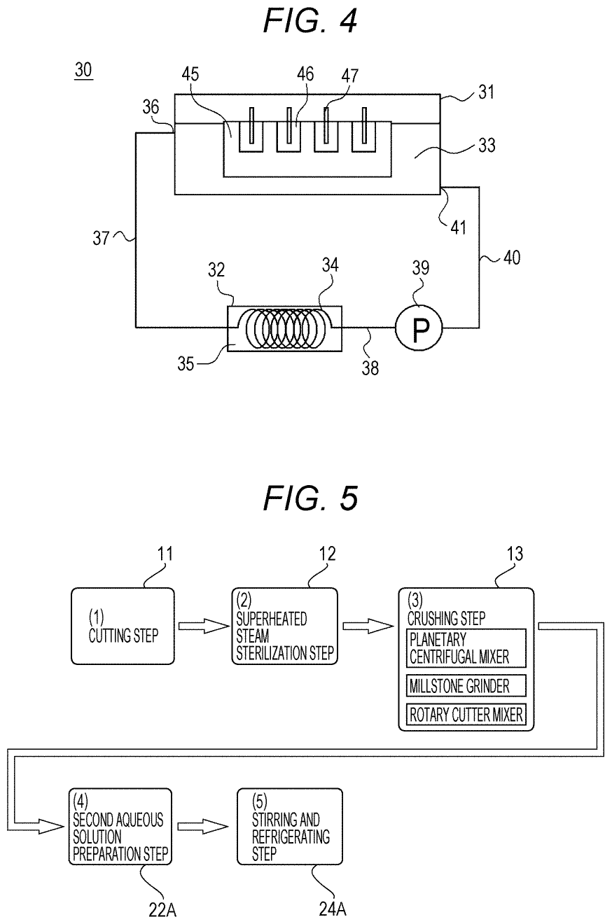

With reference to FIG. 3 and FIG. 4, a method and a system for producing an ice confection according to a second embodiment will be described. FIG. 3 is a process chart according to the second embodiment. In FIG. 3, the same steps as in FIG. 1 are denoted by the same reference signs, and a detailed description therefor may be omitted. Production steps 20 for an ice confection according to the second embodiment include the cutting step 11, the superheated steam sterilization step 12, the crushing step 13, a first aqueous solution preparation step 21, a second aqueous solution preparation step 22, an in-mold injection step 23, and a refrigerating step 24 in this order. Since the method for producing puree or paste of an ingredient in the production steps 20 for an ice confection according to the second embodiment is the same as that in the first embodiment, a description for the cutting step 11, the superheated steam sterilization step 12, and the crushing step 13, which correspond to the method for producing puree or paste of an ingredient, will be omitted.

In the first aqueous solution preparation step 21, water, a stabilizer, and a sweetener are put into a pastelizer, and the mixture is heated at a temperature of 80° C. to 85° C. for five minutes or more, for example, to be sterilized. Thus, a first aqueous solution is prepared. In this process of preparing the first aqueous solution, juice may be further put into the pastelizer. Furthermore, if there is a material to be added to the ice confection (such as a material for adjusting the flavor of the ice confection), the material is put into the pastelizer in this first aqueous solution preparation step 21. For example, warm water at about 15° C. to 70° C. may be used instead of water. Furthermore, the stabilizer may be dissolved in water or warm water before being put into the pastelizer.

The stabilizer is not limited to particular types. For example, any one of kudzu starch, kudzu powder, lotus root powder, rice flour, brown rice flour, bracken starch, potato flour, agar, and gelatin is selected, or a combination of two or more of these is used. The selection, the amount, the proportion, and the average particle size of the stabilizer determine a unique texture provided to the ice confection. For example, addition of kudzu starch provides unique thickened feeling, addition of lotus root powder provides chewy feeling, and addition of rice flour provides gooey feeling. Addition of kudzu powder provides some thickened feeling, addition of bracken starch provides crispiness, addition of potato flour provides sticky feeling, addition of agar provides crunchy feeling, and addition of gelatin provides a texture with a subtle firmness. Combinations of these can provide different textures. In addition, when these stabilizers are provided in a fine powder form, for example, when the average particle size of the stabilizers is reduced to the order of nanometers, the advantageous effects of the stabilizers are exhibited more prominently. The size of the fine powder is not limited to nanometers. For example, the powder on the order of micrometers can also provide the “binder” effect as the stabilizers.

Although brown rice flour is known to have much plant fiber and nutrient than general rice flour, using commercially available brown rice flour alone, which is simply crushed, fails to provide what is called the “binder” effect, but results in an ice confection with a dried texture. However, when brown rice flour is ground into fine powder to the order of nanometers, for example, the “binder” effect starts to be exhibited, which can produce an ice confection that has unique chewy feeling, that is stickier than with rice flour, and that provides melting feeling for a long period of time.

By selecting and combining any of the stabilizers specified above as appropriate, an ice confection that is less likely to drip can be produced. Among them, when using kudzu starch as the stabilizer in particular, an ice confection that has unique thickened feeling and is less likely to drip can be produced. For example, the stabilizer can contain 100% kudzu starch. Furthermore, when the stabilizer includes kudzu starch as a main ingredient (it is sufficient if the proportion of kudzu starch is the highest among the components, while kudzu starch preferably accounts for at least 50%) and also contains a mix of lotus root powder and/or rice flour, an ice confection that has a unique texture and is less likely to drip can be produced. This dripping prevention effect can be further enhanced through the use of the puree or paste of the ingredient described in the first embodiment. Selecting the stabilizers as appropriate can improve texture and achieve the dripping prevention effect.

By using the stabilizer in a powder form (including a fine particle form), which is easy to handle, production steps can be simplified and the amount of water can be easily adjusted. A certain amount of a stabilizer in a powder form and a certain amount of a sweetener are added to water or warm water measured to a certain amount, and the mixture is stirred to be well dissolved. The stabilizer in a powder form and the sweetener are easily dissolved in warm water at a comparatively high temperature, but the stabilizer and the sweetener are hard to dissolve in water at a low temperature, which requires thorough stirring. In addition, the particle size of the powder also affects how easy it is to dissolve.

Specifically, finer powder is easier to dissolve in water or warm water.

Preferably used as the sweetener are wasanbon, agave syrup, brown sugar, maple syrup, and non-centrifugal sugar, which have lower GI values than that of refined sugar and contain mineral components. None of the refined sugar components (such as granulated sugar, white refined sugar, ice sugar, powdered sugar, and soft brown sugar) or glucose, which are sweeteners with a health risk known to have high GI values, is included. Thus, a healthy mochi-like food product can not only prevent sharp postprandial blood sugar elevation but can also be sweet and yet be suitable for health oriented diet due to the absence of synthetic sweetener. When fruit is used as an ingredient, agave syrup is preferable as the sweetener, for example. To leverage Japanese flavoring, wasanbon is preferable as the sweetener, for example. By using the sweetener in a powder form, which is easy to handle, production steps can be simplified and the amount of water can be easily adjusted. For example, agave syrup can be made into a powder form.

In the second aqueous solution preparation step 22, the puree or paste of the ingredient processed in the crushing step 13 is added to the first aqueous solution prepared in the first aqueous solution preparation step 21. Thus, a second aqueous solution is prepared. The puree or paste of the ingredient is fibrous, and the first solution may have thickened feeling. Thus, after the puree or paste of the ingredient is added to the first aqueous solution, the puree or paste of the ingredient and the first aqueous solution is well stirred to be well mixed with each other. The puree or paste of the ingredient in this process has been heated and sterilized in the superheated steam sterilization step 12, and needs not to be heated and sterilized again. Thus, the ice confection that is less likely to drip can be produced without compromising the flavor and color of the ingredient. While the first aqueous solution preparation step 21 and the second aqueous solution preparation step 22 are separately described above, these two steps may be integrated, so that ingredients are mixed simultaneously or one after another in an appropriate order and timing. Furthermore, while the use of the pastelizer is described above, this should not be construed in a limiting sense. For example, a sterilization machine manufactured by Tomishige Sangyo K.K., which will be described in the fifth embodiment below, may be used instead.

In the in-mold injection step 23, the second aqueous solution is injected into a mold having a certain shape. While the mold is not limited to particular shapes, a mold having a substantially cylindrical or substantially rectangular parallelepiped shape can make an easy-to-eat popsicle. Furthermore, employing a cylindrical shape features uniform temperature conductivity when frozen, which can provide a preferable texture. The popsicle also features uniform temperature conductivity at room temperature, and thus is less likely to drip. The popsicle with a size of about 30 cc is handy, whereby a more easy-to-eat ice confection can be provided, but this should not be construed in a limiting sense. In addition, by inserting a holding stick in a mold having a certain shape into which the second aqueous solution has been injected, an easy-to-eat popsicle can be produced.

In the refrigerating step 24, the second aqueous solution injected in the mold is refrigerated and frozen, with a refrigerant circulating around the mold. FIG. 4 is a conceptual diagram of a refrigerator used in the second embodiment. The refrigerator 30 used in this example is small-sized, which is commonly used in stores, and includes a rectangular container 31 and a heat exchanger 32. The rectangular container 31 incorporates a cooling medium (refrigerant) 33. Liquefied nitrogen 35 is introduced into the heat exchanger 32 incorporating a copper conduit 34 wound into a coil, and thus cools the refrigerant flowing in the copper conduit 34. The rectangular container 31 has an outlet end 36 connected to one end portion of the copper conduit 34 via a conduit 37. The copper conduit 34 has the other end portion connected to an inlet end 41 of the rectangular container 31 via a conduit 38, a circulation pump 39, and a conduit 40.

FIG. 4 illustrates the second aqueous solution 46 injected into a popsicle mold 45 and holding sticks 47 inserted into the second aqueous solution 46. An upper side of the rectangular container 31 can be opened or sealed as appropriate. The refrigerant used in this example is alcohol (ethyl alcohol).

With this configuration, the refrigerant 33 in the rectangular container 31 enters the copper conduit 34 in the heat exchanger 32 from the outlet end 36 through the conduit 37, to be cooled by the liquefied nitrogen 35 to a temperature at or lower than −30° C. Then, the refrigerant 33 is circulated back into the rectangular container 31 through the conduit 38, the circulation pump 39, the conduit 40, and the inlet end 41 of the rectangular container 31. In this process, the refrigerant 33 in the rectangular container 31 is maintained to be at a temperature at or lower than −27.5° C. Thus, the second aqueous solution 46 injected into the popsicle mold 45 is rapidly cooled, so that the freezing can be completed within approximately five minutes.

The temperature difference involved in this process, by taking the popsicle mold 45 out of the rectangular container 31 to be exposed to water, partially melts the surface of the ice confection. Thus, the ice confection is able to be taken out from the popsicle mold 45 with the holding stick 47 held. The ice confection thus taken out is packaged by an automatic packaging apparatus (not illustrated). Thus, the ice confection packaged in a bag according to the second embodiment is produced.

The method for producing an ice confection according to the second embodiment can produce, by using the puree or paste of the ingredient, an ice confection that is less likely to drip without compromising the flavor and color of the ingredient. In addition, since no complicated production steps are involved, a method for producing an ice confection that can simplify production steps can be provided. Furthermore, with the method for producing an ice confection according to the second embodiment, by selecting appropriate ingredients and materials, production conforming to the Japanese Agricultural Standards (JAS) for organic foods can be performed. The popsicle mold 45 can be replaced with a mold that enables simultaneous production of a large number of small cube-form ice confections or a large-capacity bulk-size mold for commercial use.

### Third Embodiment

Next, a method and a system for producing an ice confection according to a third embodiment will be described. While the method for producing an ice confection according to the third embodiment differs from the method according to the second embodiment in producing an ice confection having a unique texture, as well as making the best use of a Japanese material, the process chart in FIG. 3 is employed commonly to the method for producing an ice confection according to the second embodiment. In the process chart in FIG. 3, details of the first aqueous solution preparation step 21 differ from those in the second embodiment.

In the third embodiment, the type of the stabilizer is specified to provide unique texture. The stabilizer contains kudzu starch as a main ingredient, but includes none of potato starch, sweet potato starch, corn starch, or wheat starch. The term “kudzu starch” herein means starch made only from kudzu root (100%) and does not include anything called kudzu starch if it contains other types of starch than starch made from kudzu root. The phrase “including kudzu starch as a main ingredient” in the present invention means the proportion of kudzu starch is the highest among the components, while it is most preferable that kudzu starch account for at least 50% by mass. This ice confection can be edible as is as a tasty ice confection providing unique thickened feeling with a texture depending on the mochi-like food product substantially before being frozen, when the temperature rises in the mouth. Furthermore, the ice confection left at room temperature does not collapse or drip and is edible as a mochi-like food product.

If the stabilizer contains only the kudzu starch, the ice confection is edible as is as a tasty ice confection, with some crispiness, providing unique thickened feeling with a texture depending on the mochi-like food product substantially before being frozen, when the temperature rises in the mouth. Furthermore, the ice confection left at room temperature does not collapse or drip and is edible as a mochi-like food product.

If a mixture of kudzu starch with lotus root powder and/or rice flour is used as the stabilizer, when the ice confection is tasted, a texture including unique thickened feeling provided by kudzu starch, as well as chewy feeling provided by lotus root powder and/or gooey feeling provided by rice flour can be felt in response to a temperature rise in the mouth. Furthermore, the ice confection left at room temperature does not collapse or drip and is edible as a mochi-like food product.

Commercially available Yoshino-hon kudzu (registered trademark) starch was used as kudzu starch serving as the stabilizer. Yoshino-hon kudzu starch is one type of kudzu starch and the one made by Kurokawa-Honke was used. Lotus root powder and wasanbon both made in Tokushima Prefecture were used. As the rice flour, commercially available fine rice flour made by crushing raw non-glutinous rice was used.

The sweetener includes at least a material that is not refined, but includes none of refined sugar, glucose, or synthetic sweeteners. Among these, wasanbon is preferably used for making the best use of a Japanese material, in terms of taste. This is because wasanbon is a type of non-centrifugal sugar, has a lower GI value than that of refined sugar, and contains mineral components.

### Example 1

A description is given on the case where 6 parts by mass of kudzu starch and 6 parts by mass of lotus root powder, both serving as stabilizers, are added to 100 parts by mass of water, and wasanbon is used as a sweetener in the first aqueous solution preparation step 21 according to the third embodiment. An appropriate amount of wasanbon, 6 parts by mass of kudzu starch and 6 parts by mass of lotus root powder, serving as stabilizers, were added to 100 parts by mass of water in a container. The mixture was well stirred and mixed so that the kudzu starch and the lotus root powder were dispersed in the water and the wasanbon was completely dissolved in the water. Next, the container was heated up to 80° C. or more with medium flame while stirring the mixture. The mixture in the container started to solidify and had its transparency increased, upon reaching a temperature around 70° C. When the mixture in the container started to solidify, strength of the stirring was sharply increased so that the mixture in the container turned into a uniform gelatinous body, and thus a first aqueous solution was prepared. The maximum heating temperature is preferably 90° C. or lower to prevent the mixture from boiling. In this process of preparing the first aqueous solution, if there is a material to be added to the ice confection (such as a material for adjusting the flavor of the ice confection), the material is added in this first aqueous solution preparation step 21.

After that, in the second aqueous solution preparation step 22, the first aqueous solution is mixed with the puree or paste of the ingredient to obtain a second aqueous solution. Since the first aqueous solution is a gelatinous body in the third embodiment, they need to be thoroughly mixed. In this process, the puree or paste of the ingredient has been heated and sterilized in the superheated steam sterilization step 12, and needs not to be heated and sterilized again. Thus, the ice confection that is less likely to drip can be produced without compromising the flavor and color of the ingredient. Furthermore, in the in-mold injection step 23, since the second aqueous solution is a gelatinous body, the second aqueous solution is injected into a piping bag, and is injected into a metallic popsicle mold (e.g., with a volume of 30 cc) having a cylindrical internal shape.

The ice confection in Example 1 provided thickened feeling as well as chewy feeling, and was also easy to bite and eat. This ice confection did not collapse or drip even when it was left at room temperature, and was edible as a mochi-like food product.

### Example 2

In Example 2, except that 6 parts by mass of kudzu starch, 3 parts by mass of lotus root powder, 3 parts by mass of rice flour, which served as starch gellants, and an appropriate amount of wasanbon were added to 100 parts by mass of water, an ice confection was produced as in Example 1. The ice confection in Example 2 provided gooey feeling, thickened feeling, and some chewy feeling. This ice confection did not collapse or drip even when it was left at room temperature, and was edible as a mochi-like food product.

### Example 3

In Example 3, except that 11 parts by mass of kudzu starch and an appropriate amount of wasanbon were added to 100 parts by mass of water, an ice confection was produced as in Example 1. The ice confection in Example 3 provided crispiness and further featured thickened feeling when being melted. This ice confection did not collapse or drip even when it was left at room temperature, and was edible as a mochi-like food product.

Thus, an ice confection can be produced that has a unique texture, does not collapse or drip even when it is left at room temperature, and is edible as a mochi-like food product. The proportions of lotus root powder and rice flour to be added are optionally adjustable as long as kudzu starch accounts for at least 50%. For example, various compositions including the following may be implemented:
kudzu starch: 100%
kudzu starch: 50%, lotus root powder: 50%
kudzu starch: 50%, lotus root powder: 25%, rice flour: 25%
kudzu starch: 50%, rice flour: 50%.

The popsicle having a cylindrical shape features uniform temperature conductivity when frozen, which is likely to lead to a texture with unique thickened feeling. The popsicle also features uniform temperature conductivity at room temperature, and thus is less likely to drip. The popsicle with a size of about 30 cc is handy, whereby a more easy-to-eat ice confection can be provided.

The ice confection may have a substantially rectangular parallelepiped shape resembling Japanese confections such as Yokan and Uiro. Such an ice confection can be eaten like the Japanese confections such as Yokan and Uiro. The ice confection may be a bite-sized and substantially rectangular parallelepiped, substantially cylindrical, or substantially spherical ice confection. Also in this case, an easy-to-eat ice confection can be provided.

To make the best use of a Japanese material, green bamboo is preferably adopted as the material of a holding stick. In the present invention, the green bamboo stick is frozen and stored together with the ice confection and thus can be maintained to have fresh green color, without oxidizing to be whitened as in a case of green bamboo stored at room temperature after being cut. The green bamboo stick of the popsicle not being whitened proves that the popsicle has not been kept at room temperature.

While the use of the stabilizer including kudzu starch as the main ingredient is described in the present embodiment, this is not construed in a limiting sense. For example, a stabilizer including brown rice flour in a fine powder form as the main ingredient, a stabilizer including rice flour as the main ingredient, and the like can be used as well.

### Fourth Embodiment

The following describes a method and a system for producing an ice confection according to a fourth embodiment. The method for producing an ice confection according to the fourth embodiment differs from the method according to the second embodiment and the third embodiment in further adding powdered material in the first aqueous solution preparation step 21 or the second aqueous solution preparation step 22 in FIG. 3.

The powdered material to be added is not limited to particular types. For example, any one of alcohol (ethyl alcohol), vitamin preparations, dietary fibers, food flavors, spices, and seasonings or a combination of two or more of these can be adopted. Adding the powdered material can add various flavors to an ice confection and prevent the ice confection from dripping. For example, if liquid alcohol (ethyl alcohol) is added to an ice confection, the ice confection is difficult to chill while being refrigerated and easy to melt. To address this, by using alcohol (ethyl alcohol) in a fine powder form, even if it is added to the first aqueous solution, the ice confection is easy to chill while being refrigerated and can be prevented from dripping. Examples of the alcohol (ethyl alcohol) in a fine powder form can include whiskey, vodka, Japanese sake, and plum wine, but this should not be construed in a limiting sense.

### Fifth Embodiment

With reference to FIG. 5, a method and a system for producing an ice confection according to a fifth embodiment will be described. FIG. 5 is a process chart according to the fifth embodiment. Production steps 20 for an ice confection according to the fifth embodiment include the cutting step 11, the superheated steam sterilization step 12, the crushing step 13, a second aqueous solution preparation step 22A, and the stirring and the refrigerating step 24. Since the method for producing puree or paste of an ingredient in the production steps for an ice confection according to the fifth embodiment is the same as that in the first embodiment, a description for the cutting step 11, the superheated steam sterilization step 12, and the crushing step 13, which correspond to the method for producing the same, will be omitted. In FIG. 5, the same steps as in FIG. 1 and FIG. 2 are denoted by the same reference signs, and a detailed description therefor are omitted.

In the fifth embodiment, the first aqueous solution preparation step is omitted. In the second aqueous solution preparation step 22A, the puree or paste of the ingredient (a drink containing a flavor material can be used in place of or in addition to this), a stabilizer, a sweetener, and a flavoring material (for example, flavoring powder of various flavors, spices, seasonings, alcohol) are put together in a heating mixer so that the stabilizer can be well dissolved. The heating temperature in the heating mixer is, for example, 85 to 99° C., and is about 98° C. to about 99° C. (below 100° C., for example. In the second aqueous solution preparation step 22A, a sterilization machine manufactured by Tomishige Sangyo K.K. was used. This single sterilization machine functions to blend and dissolve, sterilize, and cool the material. When a comparatively high heating temperature is set, the stabilizer is easy to dissolve. This heating mixer can also perform sterilization. The timing at which the ingredient is put into the heating mixer can be adjusted as appropriate depending on the states of the ingredient. For example, puree or paste of an ingredient that has been sterilized in the superheated steam sterilization step 12 may be put into the heating mixer at a later timing. The second aqueous solution preparation step 22A may be replaced with the first aqueous solution preparation step 21 and the second aqueous solution preparation step 22, as in the second embodiment.

If the frozen puree or paste or the drink containing a flavor material is frozen, they are thawed before being put into the heating mixer. For thawing, a Depak Freshness Keeping and Thawing Machine manufactured by Santetsu Engineering Inc. is used, for example, which applies electric energy sourced from high-voltage electrostatic induction generated by Depak to an ingredient and thaws it, whereby the ingredient can be thawed while maintaining its freshness.

In the stirring and refrigerating step 24A, a gelato machine manufactured by Tomishige Sangyo K.K. is used. While being refrigerated in the stirring and refrigerating device, the second aqueous solution 46 is stirred and the air is entrained therein, so that the ice confection contains fine air bubbles to put the air into the ice confection. The ice confection containing fine air bubbles is not too hard, easy to bite, and has a light mouthfeel and a preferable texture. Fine air bubbles with a smaller diameter for the same content of air per unit volume can provide a smoother mouthfeel. By decreasing the cooling rate and increasing the stirring rate to increase the stirring strength, air bubbles have a reduced diameter and the amount of air entrained is increased. In other words, the overrun of the ice confection can be adjusted by controlling the stirring rate. The stirring rate of the stirring and refrigerating device can be adjusted automatically or manually, depending on the types and states of the ingredient and the stabilizer, environmental conditions (e.g., temperature, humidity), the finished state (e.g., texture and food taste), and the like. Automatic control can be performed by remote control (for example, remote control following instructions from a server).

The ice confection containing fine air bubbles is easily scooped with a spoon or scoop, and can be provided with a unique airy texture. Typical ice cream has an overrun of 60% to 100%. If the overrun of the ice confection according to the present embodiment is 60% or more, an ice confection that is not too hard and provides a favorable texture can be produced. A larger overrun leads to a softer texture. The overrun beyond 300% results in an ice confection that is too soft with a poor texture. For this reason, the numerical range of the overrun is preferably from 60% to 300% inclusive, preferably from about 150% to about 250% for example, or preferably about 200% for example. In addition, an ice confection containing fine air bubbles such that the numerical range of the overrun is from 150% to 250% inclusive is easily scooped with a spoon or scoop. Examples of the unique airy texture of the ice confection, which is also adjustable based on the overrun, include a favorable texture between those of sorbet and ice cream and a favorable texture between those of soft-serve ice cream and gelato. The upper limit of the overrun, which is not limited to a particular value, is about 300% for example. A lower overrun results in unique gooey feeling standing out, due to starch gellant with the kudzu starch serving as the main ingredient, and a heavier food taste, whereas a higher overrun results in an airier texture and a lighter food taste.

Furthermore, since the ice confection containing fine air bubbles is easily scooped with a spoon or scoop, it can be not only served as an ice cream bar or an ice confection contained in a cup, but also supplied in a large-capacity bulk-size container (ice cream container) for commercial use, for example, a container having a volume of about 2 to 10 liters.

The ice confection according to the present embodiment can be served in at least one form selected from a soft-serve ice cream form, a popsicle form, an ice cream cup form, a wafer ice cream form, a shaved ice form, and the like.

A description is given on the ice confection in a soft-serve ice cream form. A description is given on the ice confection in a soft-serve ice cream form. The ice confection immediately after being taken out from the freezer for gelato or soft-serve ice cream is in a soft-serve ice cream form because the overrun is 60% or more (the form is adjustable, based on the level of overrun, to be in an ice cream form, a soft-serve ice cream form, a gelato form, a sorbet form or the like. Here, for example, the ice confection is in a state of having a favorable texture between those of sorbet and ice cream or between soft-serve ice cream and gelato). The ice confection can be arranged on an ice cream cone or in a container, to be served in the form of soft-serve ice cream.

A description is given on the ice confection in a popsicle form. The ice confection taken out from the freezer for gelato or soft-serve ice cream may be injected into a popsicle mold, and cooled by a refrigerator using alcohol as a refrigerant, for example. Thus, the ice confection can be served in the popsicle form. Holding sticks may be inserted as needed.

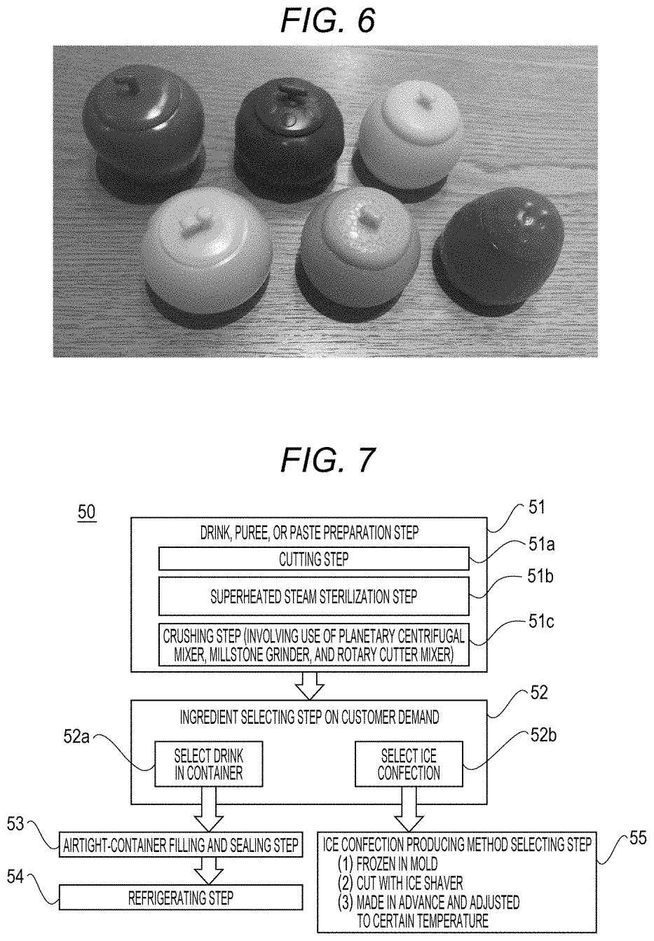

A description is given on the ice confection in an ice cream cup form. The ice confection taken out from the freezer for gelato or soft-serve ice cream may be put into a container of an appropriate size, and the container may be frozen and stored in a refrigerator. By using the container having a large capacity (for example, about 2 liters to 10 liters, such as 2 liters or 4 liters), the ice confection can be provided for commercial use. In a store, the ice confection can be scooped from the large capacity container using an ice disher and the like onto a small container, to be served as an ice confection in an ice cream cup form. The container containing the ice confection taken out from the freezer for gelato or soft-serve ice cream may be a cup made of paper, resin, or the like for a single person, to be servable as an ice cream cup with the container. Since the ice confection containing fine air bubbles is easily scooped with a spoon or scoop, an ice confection contained in a cup can be served. Alternatively, as illustrated in FIG. 6, containers mimicing the shapes of ingredients can be used. To be environmentally friendly, the cup is preferably made of material with less environmental load. For example, paper cups can be used. To make containers mimicing the shapes of ingredients, for example, biodegradable alternative plastics (e.g., limestone), bioplastics (e.g., cassava), and the like are suitably used. The cups are not limited to particular shapes, and can have shapes of a strawberry, a tangerine, a peach, a grape, a melon, a coconut, and an almond, for example.

A description is given on the ice confection in a wafer ice cream form. The ice confection taken out from the freezer for gelato or soft-serve ice cream, the ice confection frozen and stored, or the ice confection put in a popsicle mold and cooled to be solidified in a refrigerator using alcohol as the refrigerant for example may be sandwiched by wafers of an appropriate size and shape to be servable as the ice confection in a wafer ice cream form. The shape of the ice confection is not limited to a cylindrical shape, and may be a rectangular columnar shape. The wafers may have a shape conforming to that of the ice confection. For example, the ice confection may have a rectangular parallelepiped shape. The wafers may have any configuration with which the ice confection can be covered, and thus rectangular parallelepiped wafers may be also used for a cylindrical ice confection, for example. An appropriate amount of the ice confection may be taken out from the freezer and sandwiched by the wafers as is. Alternatively, an ice confection frozen and stored may be scooped with an ice disher for example, and then sandwiched by the wafers.

The wafers may have a size corresponding to the size of an ice confection for a single person. The wafers may have any shape such as a circular shape, an oval shape, a polygonal shape, a bowl shape, or a planer shape. The holding stick may or may not be provided. If the holding stick is not provided, the ice confection has a design similar to that of a wafer cake called monaka, which is a Japanese confection. If there is no holding stick, a wire shaped member may be inserted in the heated/mixed aqueous solution (such as the gelatinous body according to Experimental Example 1 and the second aqueous solution according to Experimental Example 21) in advance, so that the frozen ice confection can be easily taken out from the popsicle mold. The color of the wafers is not limited to light brown. The wafers may be colored with a natural ingredient, for example, to be white, red, or the like. Furthermore, black wafers may be obtained by adding bamboo charcoal. Thus, an ice confection in the form of an ice wafer cake with an excellent design in terms of shape, color, and the like can be provided.

A description is given on the ice confection in a shaved ice form. The ice confection taken out from the freezer for gelato or soft-serve ice cream is soft. Thus, the ice confection is put in an appropriate container and cooled in a refrigerator using alcohol as the refrigerant for example, whereby the ice confection in a solid state can be produced. The container may have a size large enough to be usable in a commercial ice shaver or the size of a popsicle. For example, the container may have an elongated bar shape (cylindrical or rectangular columnar shape), or a small (bite sized) rock or cube shape. As in Experimental Example 12 and Experimental Example 22, the ice confection may be shaved by an ice shaver to be servable as the ice confection in a shaved ice form. Furthermore, in the same manner as Experimental Example 12 and Experimental Example 22, by further refreezing the shaved ice confection, an ice confection with a different texture may be achieved.

### Sixth Embodiment

Next, a method and a system for producing an ice confection according to a sixth embodiment will be described. The method and the system for producing an ice confection according to the sixth embodiment are examples of utilizing the advantages of the methods for producing an ice confection according to the first to the fifth embodiments. These systems do not require a separate cooling tower for heat dissipation, and there is no need to drill holes for the piping of a cooling tower in a manufacturing plant. In addition, a normal commercial power supply can be used as a power supply. Furthermore, these producing methods do not include complicated steps, the steps are simplified, and the producing systems can be downsized. To this end, the producing system can be configured as a container-shaped unit. At the same time, a store or an office can be configured as a container-shaped unit. Due to their container shapes, these units can be stacked together, and can be easily installed in a small space. In addition, since these producing systems are mobile, they can be mobile factories, for example, or on-vehicle factories, for example. Furthermore, the system for producing an ice confection of the present embodiment enables production of ice confections near a sales store or in a sales store.

In addition, since the production of ice confections can be performed near or in a sales store, ice confections having various flavors according to customers' orders can be produced and provided in a short period of time as described in a seventh embodiment and a tenth embodiment to be described later, for example. That is, this system enables on-site production of ice confections in which an order is placed by a customer at a sales store and then an ice confection having a flavor according to the order is produced (refer to the seventh embodiment and the tenth embodiment for specific examples of the system). Although the time from receiving an order from a customer to providing the customer with a desired flavored ice confection depends on the capacity of a refrigerator, the ice confection can be provided in about 10 minutes, for example. The time can be further reduced depending on the equipment.

### Seventh Embodiment

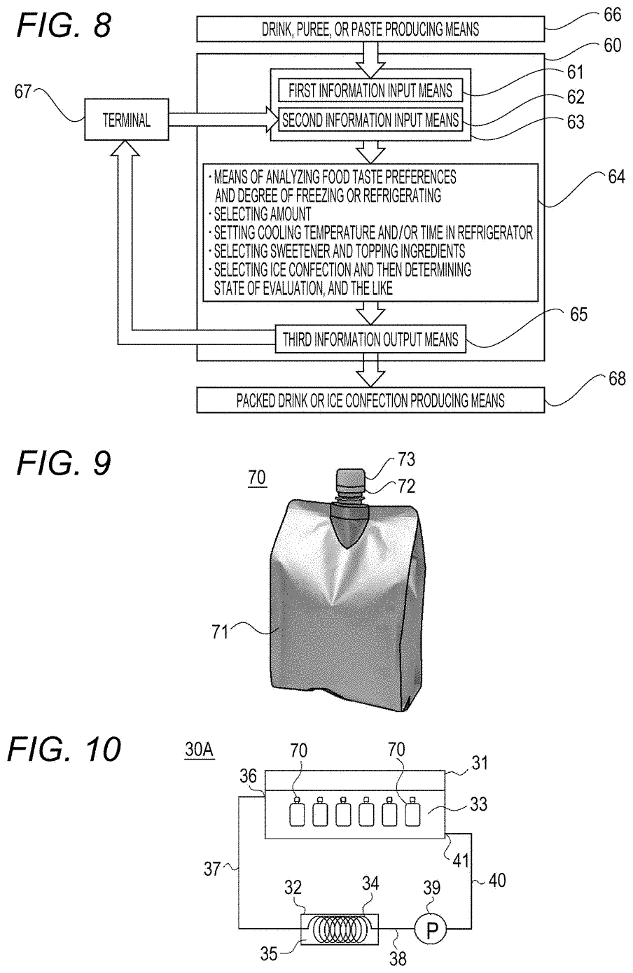

With reference to FIG. 7 and FIG. 10, a method and system for producing a packed drink according to a seventh embodiment will be described. FIG. 7 is a process chart illustrating steps for producing a packed drink according to the seventh embodiment. FIG. 8 is a block diagram schematically illustrating a packed drink producing system according to the seventh embodiment. FIG. 9 is a perspective view of an example packed drink produced. FIG. 10 is a conceptual diagram of a refrigerator.

As illustrated in FIG. 7, packed drink production steps 50 according to the seventh embodiment include a drink, puree, or paste preparation step 51, an ingredient selecting step on a customer's order 52, an airtight-container filling and sealing step 53, and a refrigerating step 54 for cooling in a refrigerator.

The drink, puree, or paste preparation step 51 includes a cutting step 51a of cutting an ingredient, a superheated steam sterilization step 51b of performing heat sterilization in a superheated steam atmosphere, and a crushing step 51c, which are the same as those in the production steps 10 for puree or paste of an ingredient according to the first embodiment illustrated in FIG. 1, and a detailed description therefor will be omitted. At the end of the crushing step 51c, the drink, puree, or paste of the ingredient is tested with metal sensors to see if there is no metallic piece included during the processing. This test with metal sensors can be performed after the drink, puree, or paste is filled and sealed in an airtight container.

The method for producing a drink, puree, or paste is not limited to the method described above. In addition, examples of the term drink, puree, or paste used herein include, as well as puree or paste produced by the production method described above, a drink containing a flavor material such as juice, carbonated drink, sports drink, coffee, tea, other teas (e.g., green powdered tea, roasted green powdered tea, green tea, oolong tea), dairy products (e.g., milk, yogurt), chocolate, and alcohols (e.g., wine, sake, Western liquor), for example.

Next, in the ingredient selecting step on a customer's order 52, with the packed drink producing system in FIG. 8 described below, an ingredient of a drink, puree, or paste is selected in accordance with the customer's order, and the temperature and duration for cooling in a refrigerator in the later refrigerating step 54 are determined in accordance with the customer's order. Also in the ingredient selecting step on a customer's order 52, the type and/or the amount of sweeteners, the type and/or the amount of topping ingredients, and the like are selected in accordance with the customer's order.

Furthermore, in the ingredient selecting step on a customer's order 52, either the selection of a drink in an airtight container 52a or the selection of an ice confection 52b can be selected. The case of selecting the selection of a drink in an airtight container 52a is first described. If a drink in an airtight container is selected, the following process involves the airtight-container filling and sealing step 53 and the refrigerating step 54 of cooling in a refrigerator.

In the airtight-container filling and sealing step 53, from among the drinks, purees, or pastes prepared in the drink, puree, or paste preparation step 51, a drink, puree, or paste of the type selected in the ingredient selecting step on a customer's order 52 is filled in an airtight container, such as a certain aluminum pouch described later, by a fixed amount with a known filling machine. In this process, to the drink, puree, or paste of the selected type, a sweetener of a type and/or an amount selected in accordance with the customer's order, a topping ingredient of a type and/or an amount selected in accordance with the customer's order, and a food additive of a type and/or an amount selected in accordance with the customer's order can be added. The amount of the drink, puree, or paste to be filled in an airtight container can be selected.

In the refrigerating step 54 of cooing in a refrigerator, the airtight container filled with the drink, puree, or paste is cooled in a refrigerator as described later, in accordance with the cooling temperature (for example, at −30° C. or lower) and duration determined in accordance with the customer's order in the ingredient selecting step on a customer's order 52. The refrigerating or cooling duration in a refrigerator maintained at −30° C. is, for example, 1 minute to obtain an optimum state as a cool drink, 3 minutes to obtain a sorbet state, and 5 to 10 minutes to obtain a completely frozen state. This can provide a packed drink in a cooled state according to a customer's request, with the drink, puree, or paste of the ingredient according to the customer's request sealed in the store.

Next, in the case where the selection of an ice confection 52b is selected in the ingredient selecting step on a customer's order 52, the process includes the ice confection producing method selecting step 55 in FIG. 7. Specifically, with the packed drink producing system 60 illustrated in FIG. 8 and described later, in accordance with the customer's order, a method for producing an ice confection is selected from among a plurality of methods, the type and/or the amount of sweeteners are selected in accordance with the customer's order, the type and/or the amount of food additives including stabilizers are selected in accordance with the customer's order, and the type and/or the amount of topping ingredients are selected in accordance with the order. As the method for producing an ice confection, one or more of the production methods according to the second embodiment to the sixth embodiment described above and the production method according to the ninth embodiment described below can be employed. A description is now given as an example on cases where the following four production methods are employed in particular for the same of description. Examples of the method for producing an ice confection include the following.

(1) A method for producing an ice confection by putting a drink, puree, or paste of an ingredient that fulfills a customer's order in a mold and refrigerating it
(2) A method for producing a shaved ice confection by selecting a certain number of cube form or rock form ice confections from among a plurality of types of cube form or rock form ice confection blocks prepared in advance and shaving them with an ice shaver
(3) A method for producing an ice confection by making an ice confection that fulfills a customer's order selected from among a plurality of types of ice confections prepared in advance such that the ice confection in a state that fulfills the customer's order can be provided through temperature control according to the customer's order
(4) A method for producing an ice confection to be served in at least one selected from a soft-serve ice cream form, a popsicle form, an ice cream cup form, a wafer ice cream form, and a shaved ice form in accordance with the customer's order

The following describes a system configuration for producing a packed drink according to a customer's request with reference to FIG. 8. The packed drink producing system 60 includes information input means 63 including first information input means 61 and second information input means 62, customer preference analyzing means 64, and third information output means 65. The packed drink producing system 60 is equipped with, for example, communication means such as a personal computer, a tablet terminal, and a smartphone, input/output means, display means, and the like.

The drink, puree, or paste producing means 66 produces drinks, purees, or pastes of various types of ingredients in the drink, puree, or paste preparation step 51 illustrated in FIG. 7 as described above. Information on the drinks, purees, or pastes produced by the drink, puree, or paste producing means 66 (including information on the types and origins of the ingredients, processed states, and the like) is input to the first information input means 61. The first information input means 61 is not limited to particular means. Examples of the input means include communication means of receiving information from the drink, puree, or paste producing means 66, means of inputting information from the drink, puree, or paste producing means 66 through a storage medium, means of reading barcodes or two-dimensional barcodes, and means of inputting information through a keyboard, a touch panel, or the like.

The terminal 67 is used by a customer for inputting the second information, and is, for example, a personal computer, a tablet terminal, a smartphone, a mobile phone, and the like. As the terminal 67, personal computers and tablet terminals provided in stores that provide packed drinks can be used, and customers' personal computers, tablet terminals, smartphones, mobile phones, and the like can be used. It is desirable that the terminals have a function to communicate with the second information input means 62. This communication means is not limited to particular types. For example, wireless communications can be employed, and specific examples include 2G, 3G, 4G, 5G, Wi-Fi (registered trademark), WiMAX (registered trademark), wireless LAN, beacon, Bluetooth (registered trademark), ZigBee (registered trademark), and the like. When a customer places an order at home, Internet communications through a fixed line can be used.

The second information is interactively input through the terminal 67 to the second information input means 62, in which case, the second information input means 62 may operate on a browser or operate as an application downloaded to the terminal 67, for example.

The second information includes information on at least one of:

(a) types and/or amounts of sweeteners, topping ingredients, food additives, and the like,

(b) food taste preference,

(c) texture preference,

(d) degree of sweetness,

(e) degree of sourness,

(f) spice preference,

(g) favorite food,

(h) least favorite food,

(i) menu of a meal,

(j) body shape,

(k) constitution,

(l) physical condition,

(m) diseases,

(n) dietary restriction,

(o) allergy-provoking food, and

(p) information for identifying an individual

The second information input means 62 is capable of inputting a plurality of modes in order to input information on (a) to (p) above. These modes are not limited to particular modes. For example, the following modes (A) to (N) can be prepared. Information can be interactively input in each mode (more specifically, refer to the tenth embodiment).

(A) Mode for selecting from recommendations

(B) Mode for directly selecting sweeteners, topping ingredients, additive ingredients, and the like

(C) Mode for inputting taste preferences

(D) Mode for inputting texture preferences

(E) Mode for inputting favorite foods and least favorite foods

(F) Mode for inputting dietary balance

(G) Mode for inputting physical condition and constitution

(H) Mode for inputting food allergies

(I) Mode for inputting dietary restrictions

(J) Mode for inputting questions about vitamins or minerals

(K) Mode for inputting questions about phytochemicals

(L) Mode for inputting questions about dietary therapy

(M) Mode for inputting questions about Ayurveda

(N) Mode for selecting from personally registered information

In the second information input means 62, any one of these modes can be set in advance. A combination of these modes can also be set in advance. Furthermore, a customer may be allowed to select one or more of these modes. In this case, the customer is first prompted to select an input mode to use.

As the terminal 67, a customer's own smartphone, tablet terminal, personal computer, mobile phone, or the like can be used, so that the customer can operate the terminal 67 to perform input to the second information input means 62 regardless of the customer's location when there is enough time. For this reason, the second information input means 62 operates on a browser or operates as an application downloaded to the terminal 67, for example, thereby enabling the customer to remotely input the second information. The terminal 67 may be a terminal provided in a store, such as a tablet terminal or a personal computer.

The second information input means 62 can input, through the terminal 67, information for adding at least one of an arrangement, a pattern, a message, an illustration, a photograph, and an image to the surface of an ice confection with topping ingredients, as the second information. This can be used for representing a favorite colorful image in accordance with the customer's order or representing an image for advertisement, for example. To represent various types of images, by adding food powder to an ice confection with a printer, a clear image with a print-like finish can be represented.

The second information input means 62 allows the customer to input information by answering questions interactively. In the case of multiple-choice questions, the customer can input information by touching a touch panel on a smartphone or tablet terminal, by clicking a mouse for a personal computer, or by using numeric keys on a mobile phone. In addition, instead of multiple-choice questions, a question requiring input of letters may be used.

For example, in the mode (B) for directly selecting sweeteners, topping ingredients, additive ingredients, and the like, the following can be directly selected.

(i) Types of ingredients (grapefruit, tangerine, strawberry, pineapple, coconut, chocolate, etc. (these can be mixed as appropriate)

(ii) Selection of the amount of sweeteners (none, normal, slightly sweet, sweet)

(iii) Selection of the type of sweeteners (sugar, honey, brown sugar, agave, granulated sugar, etc.)

(iv) Selection of topping ingredients (selection of the type, amount, presence or absence of cut fruits, etc.)

(v) Selection of food additives (selection of the type (kudzu starch, etc.), amount, presence or absence of stabilizers, etc.)

(vi) Cooling time (multiple temperature zones for a drink, sorbet state, frozen state)

When a customer is allowed to select one or more of the modes, the second input means 62 first prompts the customer to select an input mode to use. In this case, either a single mode or a plurality of modes may be selected. When a plurality of modes are selected, the content of questions is automatically adjusted according to a combination of the selected modes, so that the questions of the selected modes can be matched. For example, when selecting a plurality of modes, the order of priority is considered by, for example, sequentially selecting the first priority mode, the second priority mode, the third priority mode, and so on. By doing so, the order of questions among the modes can be matched according to the order of priority, and a weight for an answer to each question can also be adjusted. This order of priority can be reflected in the order of priority of various selections in the customer preference analyzing means 64.

As an example, when the mode (I) for inputting dietary restrictions is selected as the first priority mode, and the mode (C) for inputting taste preferences is set as the second priority mode, the first question related to dietary restrictions presents categories such as low GI value and low calorie, and asks a customer to select a category, for example. Next, the second question presents more specific dietary restrictions. For example, in the case of low GI value, the maximum allowable GI value is set by selection or by inputting a numerical value. The third question presents categories such as sweetness, sourness, salty taste, umami, and astringency as taste preferences, and asks the customer to select a category. Furthermore, with respect to the selected category, the customer is asked to input a degree from a plurality of levels or as a numerical value. In this way, it is possible to set a preferred taste while satisfying dietary restrictions.

Although it has been described that a plurality of modes can be selected, mutually contradicting modes or incompatible modes are not allowed to be selected at the same time. For example, (L) and (M) are not allowed to be selected at the same time.

The customer preference analyzing means 64 analyzes the customer's food taste order items and necessary ingredients or components based on the first information input using the first information input means 61 and the second information input using the second information input means 62. The third information output means 65 outputs third information including information on a certain amount of a drink, puree, or paste selected from drinks, purees, or pastes corresponding to the first information, and information on the selected topping ingredients and food additives.

The customer preference analyzing means 64 can select a plurality of types of drinks, purees, or pastes in accordance with the customer's order, and for example, provide a drink, puree, or paste mixed with a mixer. In this case, a combination of flavors of a plurality of types of drinks, purees, or pastes can be freely selected, whereby various combinations of flavors can be achieved. For example, combinations can be freely selected such as a combination of strawberry and coconut flavors, a combination of tomato and tangerine flavors, and the like. Furthermore, in combining strawberry and coconut flavors using a drink, puree, or paste, for example, a strawberry flavor drink, puree, or paste may account for 50% of the total amount, and a coconut flavor drink, puree, or paste may account for 50% of the total amount. Alternatively, for example, a strawberry flavor drink, puree, or paste may account for 70% of the total amount, whereas a coconut flavor drink, puree, or paste may account for 30% of the total amount. In this manner, the taste can be adjusted in accordance with the customer's order. Thus, seasoning can be implemented with elaborated combinations of tastes and their amounts, whereby various different tastes, different from a drink, puree, or paste of a singular form with a single taste, can be achieved.

The customer preference analyzing means 64 can also adjust the types and the amounts of sweeteners, the types and the amounts of topping ingredients (e.g., pulp), the concentration of the drink, the types and the amounts of food additives, and the like. As a food additive, for example, serving as a stabilizer for refrigerating a drink, puree, or paste, any one of kudzu starch, kudzu powder, lotus root powder, rice flour, brown rice flour, bracken starch, potato flour, agar, and gelatin or a combination of two or more of these can be used. Examples of the food additives include alcohol (e.g., ethyl alcohol, Western liquor, sake, wine, fermented rice drink), vitamin preparations, dietary fibers, food flavors, spices, and seasonings or a combination of two or more of these, and powdered materials are preferable in particular, although this should not be construed in a limiting sense. For example, addition of kudzu starch provides unique thickened feeling when frozen, addition of lotus root powder provides chewy feeling when frozen, addition of rice flour provides gooey feeling when frozen, addition of fine brown rice flour ground to the order of nanometers, for example, provides unique chewy feeling, addition of kudzu powder provides some thickened feeling when frozen, addition of bracken starch provides crispiness when frozen, addition of potato flour provides sticky feeling when frozen, addition of agar provides crunchy feeling when frozen, and addition of gelatin provides a texture with a subtle firmness. The potato flour is not limited to particular types of potatoes, and examples thereof include taro flour, potato flour, and the like. Combinations of these can provide different textures when frozen. As described above, by selecting and combining appropriate stabilizers, a drink, puree, or paste can be produced that provides a unique texture when frozen, and is less likely to have its liquid components separated when thawed.

The customer preference analyzing means 64 determines the cooling temperature and duration in a refrigerator in accordance with the customer's order. The cooling temperature and duration in a refrigerator maintained at −30° C. is, for example, 1 minute to obtain an optimum state as a cool drink, 3 minutes to obtain a sorbet state, and 5 to 10 minutes to obtain a completely frozen state. By determining the cooling temperature and duration in the refrigerator in this manner, a packed drink in a cooling or frozen state according to the customer's request can be provided.

Based on the information interactively input in the modes (A) to (N) using the second information input means 62, the customer preference analyzing means 64 enables the customer to select any of various analysis methods including a method for inputting food tastes of the customer's preferences, a method for considering the customer's allergies and dietary restrictions, a method for analysis about phytochemicals, a method for analysis about dietary therapy, a method for analysis about Ayurveda, and the like, and thus various analysis methods can be adopted. The customer can be allowed to select any of such various analysis methods.

As the second information input using the second information input means 62, information on which to select a packed drink or an ice confection can be included. In this case, in order to provide a customer with a packed drink or an ice confection in accordance with the customer choice, the customer preference analyzing means 64 analyzes information on the recipe of a packed drink or an ice confection according to the customer choice. The third information output means 65 outputs information on production of the packed drink or the ice confection to the packed drink or ice confection producing means 68, and outputs various information on the packed drink or the ice confection to be provided to the customer to the terminal 67.

In the case where the customer selects an ice confection, information on the state of the ice confection is further input as the second information. Depending on the state of the ice confection, the customer preference analyzing means 64 determines a production method that fulfills the customer's order from among methods including the production methods (1) to (4) described above.

The method (1) is a method for producing an ice confection by putting a drink, puree, or paste of an ingredient that fulfills a customer's order in a mold and refrigerating it. As will be described in detail later, the customer preference analyzing means 64 analyzes the customer's food taste order items and necessary ingredients or components based on the first information input using the first information input means 61 and the second information input using the second information input means 62, selects one or a plurality of certain types and amounts of drinks, purees, or pastes selected from drinks, purees, or pastes corresponding to the first information, and selects topping ingredients and food additives. Examples of the food additives include kudzu starch and other stabilizers as described above. In addition to such stabilizers, examples of the food additives include alcohol (e.g., ethyl alcohol, Western liquor, wine, sake, fermented rice drink), vitamin preparations, dietary fibers, food flavors, spices, and seasonings or a combination of two or more of these, and powdered materials are preferable in particular, although this should not be construed in a limiting sense.

The third information output means 65 outputs information on the selected drinks, purees, or pastes, topping ingredients, food additives, and method for producing an ice confection, and the like as the third information. The packed drink or ice confection producing means 68 produces an ice confection in accordance with a customer's order in a store that provides ice confections in accordance with the recipe of the ice confection, the production method, and the like included in the third information upon receiving the customer's order. Since the ice confection can be produced in a short period of time by using the refrigerator described later, an ice confection freshly prepared can be provided that satisfies the customer's demands in the shop upon receiving an order from the customer in the shop.

The method (2) is a method for producing a shaved ice confection by selecting a certain number of cube form or rock form ice confections from among a plurality of types of cube form or rock form ice confection blocks prepared in advance and shaving them with an ice shaver. The method for making the shape of an ice confection into a cube form or rock form is not limited to particular methods. Examples of the method include a method for cutting a large lump block-like ice confection into small pieces, a method for using a cube form or rock form mold for refrigerating, and a method for separating a bar-like ice confection into a plurality of pieces. Examples of the first information include information on the types of ingredients of the cube form or rock form ice confections, the types and the amounts of food additives including stabilizers, the types and the amounts of sweeteners, the production methods, shapes, and sizes of the ice confections. The customer preference analyzing means 64 analyzes the customer's food taste order items and necessary ingredients or components based on the first information input using the first information input means 61 and the second information input using the second information input means 62, selects one or a plurality of certain types and numbers of cube form or rock form ice confections selected from cube form or rock form ice confections corresponding to the first information, and selects topping ingredients and food additives (the same applies as in (1) described above for the materials of the food additives).

The third information output means 65 outputs information on the selected cube form or rock form ice confections, topping ingredients, food additives, and method for producing an ice confection, and the like as the third information. The packed drink or ice confection producing means 68 produces a shaved ice confection in accordance with a customer's order in a store that provides ice confections in accordance with the recipe of the ice confection, the production method, and the like included in the third information upon receiving the customer's order. Upon receiving an order from the customer in the shop, by using a rechargeable cordless hand-held ice shaver, for example, for shaving a cube form or rock form ice confection prepared in advance, an ice confection freshly prepared can be provided that satisfies the customer's demands in front of the customer in the shop.

The method (3) is a method for producing an ice confection by making an ice confection that fulfills a customer's order selected from among a plurality of types of ice confections prepared in advance such that the ice confection in a state that fulfills the customer's order can be provided through temperature control according to the customer's order. A plurality of types of ice confections produced in advance are prepared and stored under a plurality of different temperature conditions. In this case, the first information includes, in addition to the types of ingredients of ice confections produced in advance, the types and the amounts of food additives (the same applies as in (1) described above for the materials of the food additives), the types and the amounts of sweeteners, the production method, shape, size, and the like, information on the storage states of the ice confections (information on storage temperatures and the like). The customer preference analyzing means 64 analyzes the customer's food taste order items and necessary ingredients or components based on the first information input using the first information input means 61 and the second information input using the second information input means 62, and selects the types of ice confections in consideration of the information on the types of ice confections and the storage states of the ice confections included in the first information.

The third information output means 65 outputs the information on the selected ice confection, as well as the information on the storage states of the ice confections, the production methods for the ice confections, and the like, as the third information. The packed drink or ice confection producing means 68 can provide an ice confection in a storage state that fulfills the customer's order and of a type that fulfills the customer's order, selected from among a plurality of types of ice confections prepared in advance, based also on the information on the storage states of the ice confections included in the third information. Since ice confections can be prepared in advance, for example, a mobile store can provide an ice confection in accordance with a customer's request in a storage state that fulfills the customer's request in a short period of time after receiving the customer's order. If kudzu starch is selected as the type of the stabilizer added as a food additive for the ice confection, different textures can be achieved depending on temperature conditions. The storage state (storage temperature) of the ice confection that is ready to eat differs depending on customers' requests, such as they want to eat it in the shop, they want to take their time to eat it, or they want to bring it to their home.

The method of (4) is a method for producing an ice confection to be served in at least one selected from a soft-serve ice cream form, a popsicle form, an ice cream cup form, a wafer ice cream form, and a shaved ice form in accordance with the customer's order. In this case, the customer preference analyzing means 64 analyzes the customer's order items on food tastes, ice confection forms, and the like and necessary ingredients or components based on the first information input using the first information input means 61 and the second information input using the second information input means 62, selects one or a plurality of certain types and amounts of drinks, purees, or pastes selected from drinks, purees, or pastes corresponding to the first information, and selects the types of topping ingredients, stabilizers, and food additives. Examples of the food additives include alcohol (e.g., Western liquor, wine, sake, fermented rice drink), vitamin preparations, dietary fibers, food flavors, spices, and seasonings or a combination of two or more of these, and powdered materials are preferable in particular, although this should not be construed in a limiting sense.

The third information output means 65 outputs information on the selected drinks, purees, or pastes, topping ingredients, stabilizers, food additives, and method for producing an ice confection, ice confection forms, and the like as the third information. The packed drink or ice confection producing means 68 can produce an ice confection in accordance with a customer's order in a store that provides ice confections in accordance with the recipe of the ice confection, the production method, and the like included in the third information upon receiving the customer's order.

The third information include information on selected drinks, purees, or pastes, for example, at least one of components, names, types, effects, descriptions, medical knowledge, pharmaceutical knowledge, nutritional knowledge, therapeutic knowledge, reputation, word-of-mouth information, and Internet-based information of the drinks, purees, or pastes, topping ingredients, food additives, and the like. The third information is transmitted to the terminal 67, and can be displayed on the terminal 67.

If a packed drink is selected in the second information, the third information is also transmitted to the packed drink or ice confection producing means 68. Based on the information on the selected drinks, purees, or pastes, topping ingredients, food additives, and the like, the packed drink or ice confection producing means 68 selects certain topping ingredients, food additives, and the like if one or a plurality of certain selected drink, puree, or paste is specified, mixes them as required with a mixer, fills them in an airtight container of aluminum pouch or the like, for example, and seals it. FIG. 9 is a perspective view of the filled airtight container 71, that is, the packed drink 70. A packing device for filling and sealing a drink, puree, or paste in such an airtight container 71 of aluminum pouch or the like is well known, and a detailed description therefor is omitted. In the present invention, the material of the airtight container 71 is not limited to aluminum and may be a resin film, a vapor-deposited film, a composite material film, or a plastic bottle, for example. For example, when a plastic bottle is used, supercooling is available.

The upper end of the airtight container 71 is provided with a lip 72 having a substantially hollow cylindrical shape. The outer circumference of the lip 72 has a male screw, and the outer circumference of the lip 72 is screwed with a cap 73 from above. The cap 73 seals the lip 72. Thanks to the lip 71 provided the upper end of the airtight container 71 of the packed drink 70, it is easy for the customer to drink the drink, puree, or paste filled in the airtight container 71 directly from the lip 72.

Conventional retort pouch food is sterilized at a high temperature after filled in an airtight container, but in the present invention, it is not necessary to sterilize the drink, puree, or paste after being filled and sealed in the airtight container 71 of aluminum pouch or the like. In other words, the drink, puree, or paste has been heated and sterilized in the superheated steam sterilization step 51b illustrated in FIG. 7 described above, and needs no subsequent sterilization step. Furthermore, in the superheated steam sterilization step 51b, the superheated steam sterilization device is used to perform heat sterilization for a certain period of time in a low oxygen state (lower than the oxygen level in the atmosphere) in a superheated steam atmosphere at a certain temperature. Saturated steam functions to keep the oxygen level low, for example, at an oxygen-free level (0%). In addition, by keeping the level around 0.1% to 0.2%, the ingredient can be prevented from oxidizing even when heated, which can prevent the ingredient to have compromised flavor or color.

The production method (1) is the same as in the second embodiment to the fourth embodiment, a description therefor is omitted here.

The production method (2) is the same as in the tenth embodiment and the eleventh embodiment to be described later, a description therefor is omitted here.

The production method (4) is the same as in the fifth embodiment described above, a description therefor is omitted here.

A schematic configuration of a refrigerator 30A used by the packed drink or ice confection producing means 68 (refer to FIG. 8) or the refrigerating step 54 of cooling in a refrigerator (refer to FIG. 7) will now be described with reference to FIG. 10. FIG. 10 is a conceptual diagram of a refrigerator used in a store. The refrigerator 30A used here has substantially the same configuration as that of the refrigerator 30 illustrated in FIG. 4. The same reference signs denote the same configuration as those in FIG. 4, and a detailed description therefor is omitted.

Here, the refrigerant 33 is maintained to be at a temperature at or lower than −30° C., for example, at −30° C. After the airtight-container 70 filling and sealing step 53 (refer to FIG. 7), in the refrigerating step 54 of cooling in a refrigerator (refer to FIG. 7), the airtight container 70 filled with a drink, puree, or paste (hereinafter also referred to as “packed drink 70”) is directly immersed in the cooling medium 33 in the rectangular container 31, whereby the drink, puree, or paste filled in the airtight container 70 is quickly cooled, for example, to be a cool drink ready for drink in about 1 minute, to be in a sorbet state in about 3 minutes, and to be in a completely frozen state in about 5 to 10 minutes.

Since the airtight container 70 is individually and directly immersed in the cooling medium 33 for cooling, small-lot production can be achieved more easily and efficiently than with cooling in a popsicle mold. Thus, after receiving a customer's order, a drink, puree, or paste according to the customer's order can be provided in a cooled state that fulfills the customer's request, by filling and sealing the drink, puree, or paste in the airtight container 70 and quickly cooling the packed drink directly in the refrigerator.

### Eighth Embodiment

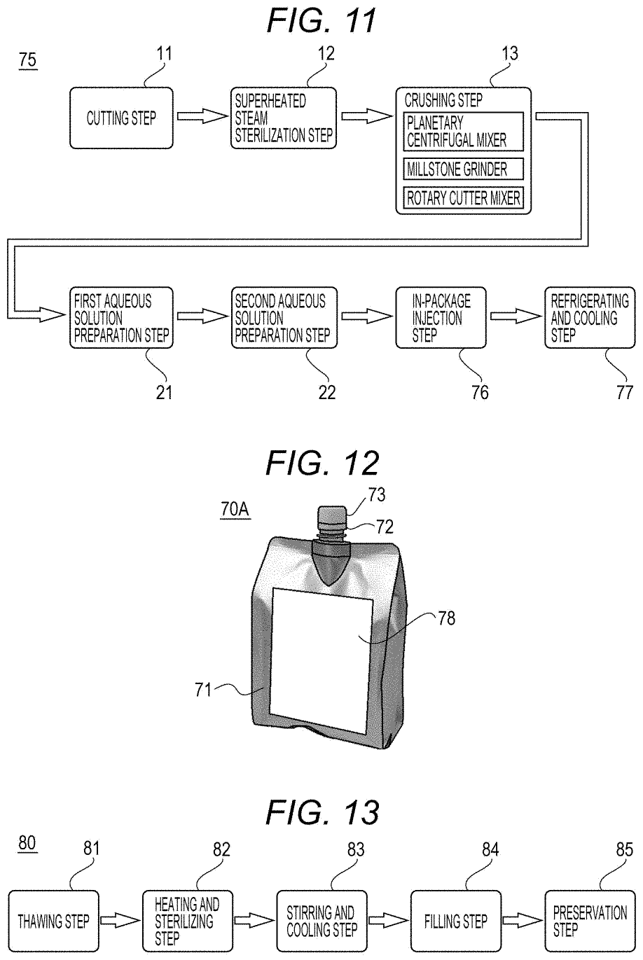

With reference to FIG. 11, production steps for a packed drink according to an eighth embodiment will be described. FIG. 11 is a process chart according to the eighth embodiment. In the present embodiment, a stabilizer is included as a food additive.

Production steps 75 for a packed drink according to the eighth embodiment include the cutting step 11, the superheated steam sterilization step 12 of performing heat sterilization in a superheated steam atmosphere, the crushing step 13, first aqueous solution preparation step 21, the second aqueous solution preparation step 22, an in-package injection step 76, and a refrigerating and cooling step 77 in this order. Since the method for producing a drink, puree, or paste of an ingredient in the production steps 75 for a packed drink according to the eighth embodiment is the same as that in the seventh embodiment, a description for the cutting step 11, the superheated steam sterilization step 12 of performing heat sterilization in a superheated steam atmosphere, and the crushing step 13, which correspond to the method for producing a drink, puree, or paste of an ingredient, will be omitted. Similarly, the in-package injection step 76 and the refrigerating and cooling step 77 are the same as in the production method for a packed drink according to the seventh embodiment, and a detailed description therefor will be omitted.

In the first aqueous solution preparation step 21, water, a stabilizer, and a sweetener are put into a pastelizer, and the mixture is heated at a temperature of 80° C. to 85° C. for five minutes or more, for example, to be sterilized. Thus, a first aqueous solution is prepared. In preparing this first aqueous solution, instead of or in addition to water, a further additional drink may be put into a pastelizer. If there are topping ingredients or food additives to be added to the drink, puree, or paste (such as a material for adjusting the flavor of the drink, puree, or paste), these materials are put into the pastelizer in this first aqueous solution preparation step 21. Examples of such materials include alcohol (e.g., ethyl alcohol, Western liquor, sake, wine, fermented rice drink), vitamin preparations, dietary fibers, food flavors, spices, and seasonings or a combination of two or more of these, and powdered materials are preferable in particular, although this should not be construed in a limiting sense. For example, warm water at about 15° C. to 70° C. may be used instead of water. Furthermore, the stabilizer may be dissolved in water or warm water before being put into the pastelizer.

The stabilizer is not limited to particular types. For example, any one of kudzu starch, kudzu powder, lotus root powder, rice flour, brown rice flour, bracken starch, potato flour, agar, and gelatin is selected, or a combination of two or more of these is used. The selection, the amount, the proportion, the powder average particle size, and the like of the stabilizer determine a unique texture provided to the ice confection when frozen. For example, addition of kudzu starch provides unique thickened feeling when frozen, addition of lotus root powder provides chewy feeling when frozen, and addition of rice flour provides gooey feeling when frozen. Addition of kudzu powder provides some thickened feeling when frozen, addition of bracken starch provides crispiness when frozen, addition of potato flour provides sticky feeling when frozen, addition of agar provides crunchy feeling when frozen, and addition of gelatin provides a texture with a subtle firmness when frozen. In addition, when these stabilizers are provided in a fine powder form, for example, when the average particle size of the stabilizers is reduced to the order of nanometers, the advantageous effects of the stabilizers are exhibited more prominently. For example, if brown rice flour having nanometer-size irregularities on the surface is added to rice flour, the mixture is stickier than with rice flour and provides melting feeling for a long period of time. The size of the fine powder is not limited to nanometers. For example, the powder on the order of micrometers can also provide the “binder” effect as the stabilizers. Combinations of these can provide different textures.

For example, the stabilizer can contain 100% kudzu starch, can include kudzu starch as the main ingredient and also a mixture of lotus root powder and/or rice flour. The unique texture when frozen is further enhanced through the use of the drink, puree, or paste of the ingredient described in the sixth embodiment. Selecting the stabilizers as appropriate can improve texture when frozen and achieve the effect of suppressing liquid separation when thawed.

By using a powder stabilizer, which is easy to handle, production steps can be simplified and the amount of water can be easily adjusted. A certain amount of a stabilizer in a powder form and a certain amount of a sweetener are added to water or warm water measured to a certain amount, and the mixture is stirred to be well dissolved. The stabilizer in a powder form and the sweetener are easily dissolved in warm water at a comparatively high temperature, but the stabilizer and the sweetener are hard to dissolve in water at a low temperature, which requires thorough stirring. In addition, the particle size of the powder also affects how easy it is to dissolve. Specifically, finer powder is easier to dissolve in water or warm water.

Preferably used as the sweetener are wasanbon, agave syrup, brown sugar, maple syrup, and non-centrifugal sugar, which have lower GI values than that of refined sugar and contain mineral components. None of the refined sugar components (such as granulated sugar, white refined sugar, ice sugar, powdered sugar, and soft brown sugar) or glucose, which are sweeteners with a health risk known to have high GI values, is included. Thus, a healthy mochi-like food product can not only prevent sharp postprandial blood sugar elevation but can also be sweet and yet be suitable for health oriented diet due to the absence of synthetic sweetener. When fruit is used as an ingredient, agave syrup is preferable as the sweetener, for example. To make the best use of Japanese flavoring, wasanbon is preferable as the sweetener, for example. By using the sweetener in a powder form, which is easy to handle, production steps can be simplified and the amount of water can be easily adjusted. For example, agave syrup can be made into a powder form.

In the second aqueous solution preparation step 22, the drink, puree, or paste of the ingredient processed in the crushing step 13 is added to the first aqueous solution prepared in the first aqueous solution preparation step 21. Thus, a second aqueous solution is prepared. The drink, puree, or paste of the ingredient is fibrous, and the first solution may have thickened feeling. Thus, after the drink, puree, or paste of the ingredient is added to the first aqueous solution, the drink, puree, or paste of the ingredient and the first aqueous solution is well stirred to be well mixed with each other. The drink, puree, or paste of the ingredient in this process has been heated and sterilized in the sterilization step 51b in a superheated steam atmosphere, and needs not to be heated and sterilized again. Thus, the flavor and color of the ingredient are not compromised. While the first aqueous solution preparation step 21 and the second aqueous solution preparation step 22 are separately described above, these two steps may be integrated, so that ingredients are mixed simultaneously or one after another in an appropriate order and timing. Furthermore, while the use of the pastelizer is described above, this should not be construed in a limiting sense. For example, a sterilization machine manufactured by Tomishige Sangyo K.K., which will be described in the fifth embodiment below, may be used instead.

The second aqueous solution thus prepared is, as in the sixth embodiment, filled in an airtight container of aluminum pouch or the like and refrigerated or cooled in a refrigerator, whereby a packed drink 70 in a cooled state according to the customer's order can be produced. With such a method for producing a packed drink according to the sixth embodiment or the seventh embodiment, by selecting appropriate ingredients and materials, production conforming to JAS for organic foods can be performed. Furthermore, such a drink after being frozen is less likely to drip even when being melted.

FIG. 12 illustrates another example packed drink. FIG. 12 is a perspective view of another example packed drink according to the eighth embodiment. Another example packed drink 70A illustrated in FIG. 12, in other words, an airtight container 71A filled with a drink or the like has a structure that differs from that of the airtight container 71 filled with a drink or the like illustrated in FIG. 7 in that a label 78 is attached to the airtight container 71A. While FIG. 12 illustrates an example in which the label 78 is attached to a part of one side of the airtight container 71A filled with a drink or the like, the label 78 may be attached to both main surfaces of the airtight container 71A filled with a drink or the like or around the entire circumference of the airtight container 71A filled with a drink or the like. The size and dimensions of the label 78 are optional. On the front surface of the label 78, for example, information on the components of the drink, puree, or paste and on topping ingredients and food additives can be described, as well as the producer of the packed drink 70A. The back surface of the label 78 is provided with an adhesive or bonding agent, so that the label 78 can be easily attached to the surface of the airtight container 71A filled with a drink or the like.

Since the airtight container 71 of the packed drink 70 has the lip 72, a customer can drink it directly from the lip 72, or may want to use a straw for drinking. To meet this demand, a straw can be stored in the space between the back surface of the label 78 and the front surface of the airtight container 71A. In this case, the adhesive or bonding agent provided to the back surface of the label is preferably selected such that the customer can easily peel the label 78. This also contributes to separate collection of used packages for recycling. Thus, attaching the label 78 to the front surface of the packed drink 70A can provide an additional function of storing a straw and an advantageous effect of improved design.

### Ninth Embodiment

With reference to FIG. 13, a method for producing an ice confection according to a ninth embodiment will be described. FIG. 13 is a process chart according to the ninth embodiment. The ninth embodiment produces an ice confection frozen with fine air bubbles entrained therein to put the air into the ice confection. While the starting material for use is assumed to be a puree or paste produced in the first embodiment that is frozen and then thawed, a freshly prepared puree or paste can be used as is if the production steps of the puree or paste are integrated, which requires no thawing step.

The method for producing an ice confection according to the ninth embodiment includes:

(1) thawing step,

(2) heating and sterilizing step,

(3) stirring and cooling step,

(4) filling step, and

(5) preservation step.

The following describes the steps in this order.

### (1) Thawing Step

First, frozen puree is slowly thawed with a thawing machine. Here, thawing is performed slowly over eight hours using an electric field applying type thawing machine manufactured by Santetsu Engineering Inc. Using this thawing machine can reduce the destruction of the tissue of ingredients contained in the frozen puree and thaw it while maintaining good taste.

### (2) Heating and Sterilizing Step

For the heating and sterilizing step, a sterilizer manufactured by Tomishige Sangyo K.K. is used. This sterilizer is equipped with three functions of mixing and dissolving, sterilizing, and cooling of raw materials in one machine. First, the puree obtained in “(1) Thawing step” and various ingredients to which a stabilizer has been added are sterilized by being heated to 98° C. to 99° C. while being stirred and mixed. The heating temperature of a conventional general pasteurizer is about 87° C.; however, heating to a high temperature of 98 to 99° C. not only enables preferable sterilization, but also improves solubility when a stabilizer such as kudzu starch is added, for example.

If a puree or paste manufacturing plant is adjacent, obtained puree or paste has already been sterilized, and there is no need to re-sterilize it. It is only necessary to mix the freshly prepared puree or paste with a sterilized ingredient such as kudzu starch. In this case, the puree or paste may be stirred and heated together with the kudzu starch or the like using the pasteurizer described above. In any case, when the puree or paste is in a freshly prepared state or in a state close to freshly prepared, a delicious ice confection can be produced.

### (3) Stirring and Cooling Step

In the stirring and cooling step, a gelato machine manufactured by Tomishige Sangyo K.K. is used. The sterilized puree or paste obtained in the above “(2) Heating and sterilization step” is cooled while being stirred in the gelato machine, so that fine air bubbles are entrained in the puree or paste to increase overrun. In particular, when kudzu starch or brown rice flour having a nanometer size is used as a stabilizer, the overrun can be increased as compared with the case where another stabilizer is used. Since this gelato machine can change the stirring speed, the optimum stirring speed can be set on the basis of the type and concentration of the ingredients, the type of the stabilizer, or the like in the puree or paste (refer to the third embodiment). The value of the overrun is controlled between 60% and 300% inclusive (refer to the third embodiment).

### (4) Filling Step

Due to the large capacity of the gelato machine described above, injection and filling of a produced ice confection into commercial bulk size containers can be directly performed from this gelato machine. On the other hand, when injecting into small or fruit-shaped cups or containers having a small capacity, the produced ice confection is transferred to a separate filling machine and then injected and filled individually. A container imitating the shape of a fruit preferably has the same fruit shape as that of the ingredient of puree or paste, such as strawberry, melon, tangerine, or peach. Furthermore, as a material for forming a small cup or a container imitating the shape of a fruit, a material made of a biodegradable substitute plastic or a bioplastic is used from the viewpoint of reducing environmental load. In addition, when a commercial bulk size container is used, since the surface area of the ice confection is large, at least one of the arrangement, pattern, message, illustration, photograph, or image according to a customer's order can be rendered on the ice confection with topping ingredients. For example, customer's favorite colorful image may be illustrated in accordance with the customer's order, or an image for advertisement may be illustrated. In addition, when illustrating various images, a vivid image similar to a printed image can be rendered by applying food powder to the ice confection with a printer.

### (5) Preservation Step

The ice confection injected and filled into an appropriate container in the above “(4) Filling step” can be stored for a long period of time by placing it in a freezer maintained at a certain temperature. As in the case of ice cream, the ice confection filled in a commercial bulk size container can be directly scooped with a spoon or scoop in a predetermined amount at the time of sale, and can be supplied to a customer in a cone-shaped container or a certain container. On the other hand, the ice confection filled into a small cup or a container imitating the shape of a fruit can be supplied to a customer as it is, and the customer can directly scoop and eat the ice confection from the container with a spoon.

### Tenth Embodiment

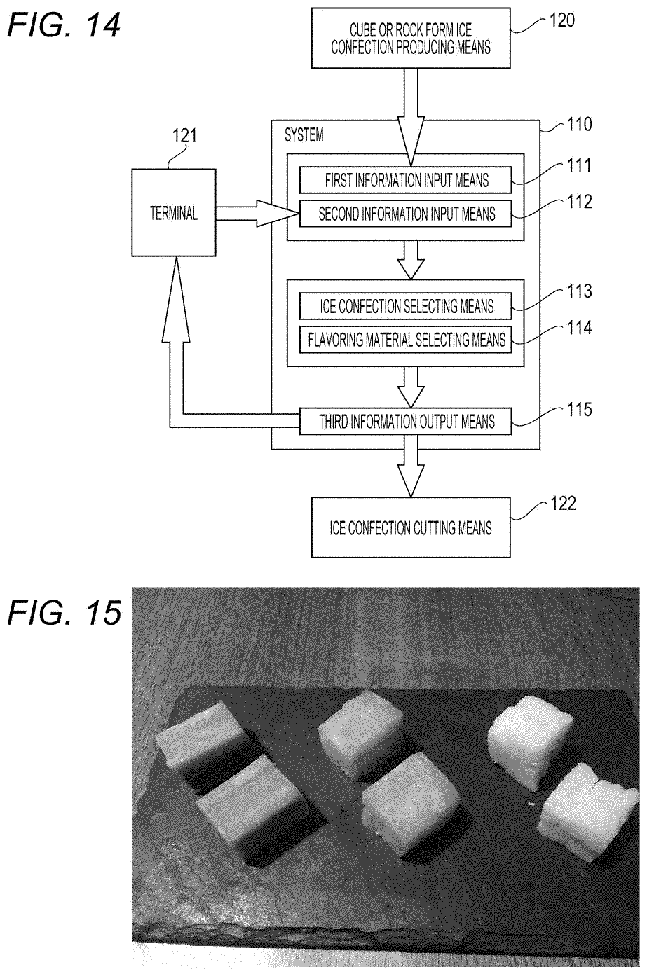

With reference to FIG. 14, a system 110 according to a tenth embodiment will be described. In the tenth embodiment, the system 110 for providing a shaved ice confection in a store will be described as an example. The system 110 includes a first information input means 111, a second information input means 112, an ice confection selecting means 113, a flavoring material selecting means 114, and a third information output means 115. The system 110 is equipped with, for example, communication means such as a personal computer, a tablet terminal, and a smartphone, input/output means, display means, and the like.

The cube or rock form ice confection producing means 120 produces a plurality of types of cube form or rock form ice confections provided with respective food tastes, the ice confections being produced by adding a flavor material. This ice confection is not limited to particular types, and may contain, as the stabilizer, any one of kudzu starch, kudzu powder, lotus root powder, rice flour, bracken starch, potato flour, agar, and gelatin is selected, or a combination of two or more of these. For example, addition of kudzu starch provides unique thickened feeling, addition of lotus root powder provides chewy feeling, addition of rice flour provides gooey feeling, addition of kudzu powder provides some thickened feeling, addition of bracken starch provides crispiness, addition of potato flour provides sticky feeling, addition of agar provides crunchy feeling, and addition of gelatin provides a texture with a subtle firmness. Combinations of these can provide different textures. Furthermore, selecting and combining stabilizers as appropriate can produce an ice confection that has a unique texture and is less likely to drip.

By using cube form or rock form ice confections, a plurality of types of ice confections can be simultaneously put into an ice shaver to produce a mixed shaved ice confection. In this case, a combination of flavors of a plurality of types of ice confections can be freely selected, whereby various combinations of flavors can be achieved. For example, combinations can be freely selected such as a combination of chocolate, green powdered tea, and strawberry flavors, and the like. Furthermore, by using rock form or cube form ice confections, when chocolate and strawberry flavors are combined, for example, two chocolate flavor ice confections and two strawberry flavor ice confections can be selected, or three chocolate flavor ice confections and one strawberry flavor ice confection can be selected, which enables adjustment of tastes in accordance with the customer's preferences. Thus, seasoning can be implemented with elaborated combinations of tastes and their amounts, whereby various different tastes, different from an ice confection of a singular form with a single taste, can be achieved.

The method for making the shape of an ice confection into a cube form or rock form is not limited to particular methods. Examples of the method include a method for cutting a large lump block-like ice confection into small pieces, a method for using a cube form or rock form mold for refrigerating, and a method for separating a bar-like ice confection into a plurality of pieces.

Information on a plurality of types of ice confections produced by the cube or rock form ice confection producing means 120 and prepared for producing a shaved ice confection is input to the first information input means 111. The first information input means 111 is not limited to particular means. Examples of the input means include communication means of receiving information from the cube or rock form ice confection producing means 120, means of inputting information from the cube or rock form ice confection producing means 120 through a storage medium, means of reading barcodes or two-dimensional barcodes, and means of inputting information through a keyboard, a touch panel, or the like.

The terminal 121 is used by a customer for inputting the second information, and is, for example, a personal computer, a tablet terminal, a smartphone, a mobile phone, and the like. As the terminal 121, personal computers and tablet terminals provided in stores that provide shaved ice confections can be used, and customers' personal computers, tablet terminals, smartphones, mobile phones, and the like can be used. It is desirable that the terminals have a function to communicate with the second information input means 112. This communication means is not limited to particular types. For example, wireless communications can be employed, and specific examples include 2G, 3G, 4G, 5G, Wi-Fi (registered trademark), WiMAX (registered trademark), wireless LAN, beacon, Bluetooth (registered trademark), ZigBee (registered trademark), and the like. When a customer places an order at home, Internet communications through a fixed line can be used.

The second information is interactively input through the terminal 121 to the second information input means 112, in which case the second information input means 112 may operate on a browser or operate as an application downloaded to the terminal 121, for example. Details of the second information input means 112 will be described later.

The ice confection selecting means 113 and the flavoring material selecting means 114 analyze the customer's preference of food tastes and/or required food or components, based on the first information input using the first information input means 111 and the second information input using the second information input means 112. The third information output means 115 outputs the third information on a certain number of cube form or rock form ice confections selected from among the cube form or rock form ice confections provided with respective food tastes input as the first information, and/or information on the selected flavoring material. Examples of the method for this analysis include a method for inputting food tastes of the customer's preferences, a method for considering the customer's allergies and dietary restrictions, a method for analysis about phytochemicals, a method for analysis about dietary therapy, a method for analysis about Ayurveda, and the like, and thus various analysis methods can be adopted. The customer can be allowed to select any of such various analysis methods.

The third information further includes, as the information on the selected ice confections or flavoring material, information on at least one of: names, types, effects, descriptions, medical knowledge, pharmaceutical knowledge, nutritional knowledge, therapeutic knowledge, reputation, word-of-mouth information, and Internet-based information of components, the flavor material, or the flavoring material of the ice confections. The third information is transmitted to the terminal 121, and can be displayed on the terminal 121.

The third information is also transmitted to the ice confection cutting means 122. Based on the information on the selected ice confection or flavoring material, a selected number of the selected cube form or rock form ice confections are put into an ice shaver and shaved. Furthermore, the selected flavoring material is added to the shaved ice confection thus shaved. As the ice shaver, an electrical or manual ice shaver for commercial or household use can be employed. It is desirable that a hand-held electrical ice shaver be used, in particular.

A method for producing a shaved ice confection according to the tenth embodiment includes steps (1) to (4):

(1) preparing a plurality of types of cube form or rock form ice confections provided with respective food tastes, the ice confections being produced by adding a flavor material;
(2) inputting information on the cube form or rock form ice confections provided with respective food tastes prepared in step (1);
(3) inputting second information from the terminal 121, analyzing preference of food tastes and/or required food or components by using the first information and the second information, and outputting third information on a certain number of cube form or rock form ice confections selected from among the cube form or rock form ice confections provided with respective food tastes input as the first information; and
(4) shaving the cube form or rock form ice confections selected based on the third information output in step (3) with an ice shaver.

The following describes the method for producing a shaved ice confection according to the tenth embodiment in sequence and in detail.

[Step of Preparing a Plurality of Types of Cube Form or Rock Form Ice Confections]

The method for producing an ice confection used in this step of preparing a plurality of types of cube form or rock form ice confections is not limited to particular methods, and the methods according to the second to the sixth and the ninth embodiments described above can be employed. With these production methods, an ice confection that has a preferable texture and food taste as a shaved ice confection can be produced. This preferable texture is considered to be attributable to the fact that the ice confection melted in the mouth is not directly turned into a liquid form but maintains gooey feeling, thickened feeling, and gummy feeling. The term gummy feeling used herein means a texture offering smoothness not quite on par with cream but with a subtle firmness, like Nama-chocolate (Japanese ganache).

The method for producing an ice confection is not limited to those described above. These methods can be combined and implemented as appropriate. While kudzu starch and other starch gellants are dissolved in water in the description above, the present invention is not limited to this. For example, kudzu starch and other starch gellants can be dissolved in rice milk, coconut water, coconut milk, or the like, instead of water. Furthermore, while the examples above use starch gallants serving as the stabilizers including kudzu starch as the main ingredient from the viewpoint of texture, starch gellants serving as the stabilizers including other material than kudzu starch as the main ingredient can be used to change the texture. While the examples above use wasanbon, agave syrup, coconut sugar, and other unrefined sweeteners as the sweetener, if GI value, mineral components, texture, and the like are not essential factors, other types of sweeteners, for example, refined sweeteners, synthetic sweeteners, and the like can be used.

### [Cube Form or Rock Form Molding Method]

FIG. 15 is a picture of an example cube form or rock form ice confection. The method for making the shape of an ice confection into a cube form or rock form is not limited to particular methods. Examples of the method include a method for cutting a large lump block-like ice confection into small pieces, a method for using a cube form or rock form mold for refrigerating, and a method for separating a bar-like ice confection into a plurality of pieces.

As the method for cutting a large lump block-like ice confection into small pieces, for example, a large lump block-like ice confection is pressed against a stainless grid-like blade, for example, whereby the block-like ice confection is cut into pieces having an elongated square columnar shape. Next, the pieces are cut across the longitudinal direction of the elongated square columnar shape with another blade placed substantially perpendicular to the grid-like blade, whereby a cube form or rock form ice confection is produced.

As the method for using a cube form or rock form mold for refrigerating, for example, a mold with grid partitions is used, whereby a plurality of cube form or rock form ice confections are produced with this single mold.

As the method for separating a bar-like ice confection into a plurality of pieces, for example, an ice confection having a rectangular columnar shape provided with notches for easy separation into a plurality of pieces is divided along the notches, whereby a plurality of cube form or rock form ice confections can be produced. Even without such notches, bar-like ice confections are easily divided into a plurality of pieces using a knife, fork, or spoon, for example, or even by bare hands. In this case, while the bar-like ice confections may or may not be each provided with a holding stick, bar-like ice confections intended to be processed into cube form or rock form ice confections require no holding stick.

### [First Information Input Means 111]

In the step of preparing a plurality of types of cube form or rock form ice confections, information on the cube form or rock form ice confections produced is input using the first information input means 111 as the first information. Examples of the first information include information on the types of flavor materials and the types of stabilizers for the cube form or rock form ice confections, and the production methods, shapes, and sizes of the ice confections.

The first information input means 111 is not limited to particular means. Examples of the input means include communication means of receiving information from the cube or rock form ice confection producing means 120, means of inputting information from the cube or rock form ice confection producing means 120 through a storage medium, means of reading barcodes or two-dimensional barcodes, and means of inputting information through a keyboard, a touch panel, or the like.

### [Second Information Input Means 112, Ice Confection Selecting Means 113, and Flavoring Material Selecting Means 114]

The second information is interactively input through the terminal 121 to the second information input means 112, in which case, the second information input means 112 may operate on a browser or operate as an application downloaded to the terminal 121, for example.

The second information includes information on at least one of:

(a) flavor material type,
(b) food taste preference,
(c) texture preference,
(d) degree of sweetness,
(e) degree of sourness,
(f) spice preference,
(g) favorite food,
(h) least favorite food,
(i) menu of a meal,
(j) body shape,
(k) constitution,
(l) physical condition,
(m) diseases,
(n) dietary restriction,
(o) allergy-provoking food, and
(p) information for identifying an individual

The second information input means 112 is capable of inputting a plurality of modes in order to input information on (a) to (p) above. These modes are not limited to particular modes. For example, the following modes (A) to (N) can be prepared. Information can be interactively input in each mode.

(A) Mode for selecting from recommendations
(B) Mode for directly selecting flavor materials and flavoring materials
(C) Mode for inputting taste preferences
(D) Mode for inputting texture preferences
(E) Mode for inputting favorite foods and least favorite foods
(F) Mode for inputting dietary balance
(G) Mode for inputting physical condition and constitution (H) Mode for inputting food allergies
(I) Mode for inputting dietary restrictions
(J) Mode for inputting questions about vitamins or minerals
(K) Mode for inputting questions about phytochemicals
(L) Mode for inputting questions about dietary therapy
(M) Mode for inputting questions about Ayurveda
(N) Mode for selecting from personally registered information

In the second information input means 112, any one of these modes can be set in advance. A combination of these modes can also be set in advance. Furthermore, a customer may be allowed to select one or more of these modes. In this case, the customer is first prompted to select an input mode to use.

As the terminal 121, a customer's own smartphone, tablet terminal, personal computer, mobile phone, or the like can be used, so that the customer can operate the terminal 121 to perform input to the second information input means 112 regardless of the customer's location when there is enough time. For this reason, the second information input means 112 operates on a browser or operates as an application downloaded to the terminal 121, for example, thereby enabling the customer to remotely input the second information. The terminal 121 may be a terminal provided in a store, such as a tablet terminal or a personal computer.

The second information input means 112 allows the customer to input information by answering questions interactively. In the case of multiple-choice questions, the customer can input information by touching a touch panel on a smartphone or tablet terminal, by clicking a mouse for a personal computer, or by using numeric keys on a mobile phone. In addition, instead of multiple-choice questions, a question requiring input of letters may be used.

When a customer is allowed to select one or more of the modes, the second input means first prompts the customer to select an input mode to use. In this case, either a single mode or a plurality of modes may be selected. When a plurality of modes are selected, the content of questions is automatically adjusted according to a combination of the selected modes, so that the questions of the selected modes can be matched. For example, when selecting a plurality of modes, the order of priority is considered by, for example, sequentially selecting the first priority mode, the second priority mode, the third priority mode, and so on. By doing so, the order of questions among the modes can be matched according to the order of priority, and a weight for an answer to each question can also be adjusted. This order of priority can be reflected in the order of priority of the selection of various ice confections in the ice confection selecting means 113 and the flavoring material selecting means 114.

As an example, when the mode (I) for inputting dietary restrictions is selected as the first priority mode, and the mode (C) for inputting taste preferences is set as the second priority mode, the first question related to dietary restrictions presents categories of dietary restrictions such as low GI value and low calorie, and asks a customer to select a category, for example. Next, the second question presents more specific dietary restrictions. For example, in the case of low GI values, the maximum allowable GI value is set by selection or by inputting a numerical value. The third question presents sweetness, sourness, salty taste, umami, astringency, and the like as the input categories of taste preference, and asks the customer to select a category. Furthermore, with respect to the selected category, the customer is asked to input a degree from a plurality of levels or as a numerical value. In this way, it is possible to set a preferred taste while satisfying dietary restrictions.

Although it has been described that a plurality of modes can be selected, mutually contradicting modes or incompatible modes are not allowed to be selected at the same time. For example, (L) and (M) are not allowed to be selected at the same time.

The modes (A) to (E) are easy to input, and thus they are suitable for inputting from the terminal 121 provided in a store. These modes are also suitable for the need of simple order from customer's own smartphone or the like. Providing multiple-choice questions can further simplify the order process. Instead of answering a single question, an order can be completed by answering a plurality of questions interactively, such as answering the second question based on the answer to the first question, and the third question based on the answer to the second question, and so on.

For example, in the mode (B) for directly specifying flavor material and flavoring material, if there are many types of flavor material or flavoring material, presenting all types of flavor material or flavoring material in one question and asking a customer to make a selection may be difficult for the customer. In such a case, the first question may ask the customer to make a selection from a rough classification of flavor materials (for example, fruit, vegetables, tea, chocolate, nuts, etc.), and the second question may present specific flavor materials based on the selection made in the first question and ask the customer to make a selection. The third question may present to the customer a rough classification of flavoring materials including an option of excluding flavoring materials, and the fourth question may present specific flavoring materials based on the selection made in the third question and ask the customer to make a selection. A single question may be provided; however, in some cases, asking the first to the fourth questions interactively as described above may be easier for the customer to make selections. Then, on the basis of the information input in this way, the information on an ice confection and a flavoring material selected by the ice confection selecting means 113 and the flavoring material selecting means 114 are output as the third information from the third information output means 115.

Furthermore, to facilitate placing orders, as in the mode (A), the second information input means 112 prepares a plurality of types of combinations of flavor materials and flavoring materials recommended by the store in advance, so that customers can order their favorite ice confection from the prefixed combinations of flavor materials and flavoring materials through interactive questions. For example, recommended categories are displayed in the first question. As the categories, for example, seasonal fruits, popular standard flavors, chocolate flavors, Japanese ice confections, and the like are displayed to prompt the customer to make a choice. In the second question, recommended ice confections in the category according to the answer to the first question are presented to prompt the customer to make a choice. Furthermore, in the third question, an addition and change of flavoring materials and the like can be selected from the combinations of flavor materials and flavoring materials prepared by the store. Based on these pieces of information, the ice confection selecting means 113 and the flavoring material selecting means 114 select an ice confection and flavoring materials.

In the mode (C) for inputting taste preferences, the second information input means 112 grasps information on the taste desired by the customer in response to the questions about taste preferences, and the ice confection selecting means 113 and the flavor-added material selecting means 114 select an ice confection and flavoring materials so as to have the customer's favorite taste based on this information.

In the mode (C), information on one or more of the five tastes that are generally tasted as delicious, that is, sweetness, sourness, salty taste, umami, and bitterness is input as the second information. The tenth embodiment can provide various tastes by combining a plurality of ice confections. As examples of the combination of flavors, a combination of chocolate and green powdered tea, a combination of strawberry and coconut, and the like can provide rich flavors. Furthermore, seasoning can be implemented with various combinations of tastes, for example, a combination of cucumber and honey produces a melon-like flavor, and a combination of tomato and agave syrup produces a strawberry-like flavor. By analyzing the tastes of flavor materials to be used for the ice confection and the tastes of flavoring materials to be added to the ice confection with taste sensors, the food taste can be quantitatively analyzed. The ice confection selecting means 113 and the flavoring material selecting means 114 select the types and the amounts of the ice confection and flavoring materials, by quantitatively analyzing the food taste of the ice confection and flavoring materials combined to accord with the second information representing the customer's preferences.

How the ice confection melts will influence the richness of the food taste, for example. For example, an ice confection including kudzu starch as the main ingredient provides unique thickened feeling, and it melts not immediately but slowly in the mouth. Thus, such an ice confection provides a texture with thickened feeling and a lingering food taste, which can be felt as a rich food taste. In this manner, the ice confection selecting means 113 and the flavoring material selecting means 114 can analyze richness as a food taste by considering the length of time it takes for an ice confection to melt in the mouth, in other words, the aftertaste of the ice confection.

In the mode (D), the second information input means 112 grasps information on the texture desired by the customer in response to the questions about texture preferences, and the ice confection selecting means 113 and the flavor-added material selecting means 114 select an ice confection and flavoring materials so as to have the customer's favorite texture based on this information.

As described above, the texture of the ice confection can be adjusted by adjusting the type and recipe of the stabilizer and the like. For example, serving as the stabilizer, kudzu starch provides unique thickened feeling, lotus root powder provides chewy feeling, and rice flour provides gooey feeling. In addition, for example, dissolving the stabilizer not in water but in rice milk can provide gummy feeling. In this manner, the texture is adjustable for each ice confection, and an ice confection having a plurality of textures can be prepared. This can take input texture preferences into consideration. Considering information on texture preferences input by the customer, the ice confection selecting means 113 selects an ice confection. Since powder flavoring materials are used, such flavoring materials typically have little influence on the texture. However, if chocolate chip, granular nut, orange puree, fruit pulp, and the like are used as the flavoring materials, for example, they influence the texture, and the second information input means 112 can also provide questions on the textures of such flavoring materials.

In the mode (E) for inputting favorite foods and least favorite foods, the second information input means 112 grasps information on favorite foods and least favorite foods of the customer in response to the questions about favorite foods and least favorite foods, and the ice confection selecting means 113 and the flavor-added material selecting means 114 select an ice confection and flavoring materials in consideration of the customer's favorite foods and least favorite foods based on this information. In other words, specific information on foods that the customer wants to or does not want to use can be grasped.

In the modes (F) to (N), questions may be complicated, and it may take time to input information. Therefore, in these modes, it is desirable to input information from the terminal 121 such as a smartphone of the customer, or to register the input content of the second information in advance. If the input content of the second information is registered in advance, the customer can easily order a favorite ice confection in the mode (N) for selecting from the personally registered information. When registering the input content of the second information in advance, the customer can freely assign a name, and can register as the customer's original ice confection.

In the mode (F) for inputting dietary balance, the second information input means 112 grasps information on the dietary balance of the customer based on questions about the dietary balance, and the ice confection selecting means 113 and the flavoring material selecting means 114 select, on the basis of this information, an ice confection and a flavoring material needed by the customer. For example, in the mode (F), question items relating to the menu of a meal of the day or the like is prepared, and in consideration of the menu of the day, the ice confection selecting means 113 and the flavoring material selecting means 114 select an ice confection and a flavoring material so as to compensate for the lack of nutrients from the viewpoint of nutritional balance. For example, when vegetables are in short supply, an ice confection with vegetable puree is selected.

On the basis of the information input in the mode (F), the ice confection selecting means 113 and the flavoring material selecting means 114 perform an analysis from the viewpoint of nutrition management, for example. Among the nutrients that are taken from food and are necessary for life support, carbohydrates, proteins, and lipids, which are particularly important, are called three major nutrients, and the three major nutrients, vitamins, and minerals are collectively called five major nutrients. In order to take in these nutrients in a well-balanced manner, food is divided into six nutritional food groups, and an analysis is performed so that ingredients can be selected from the food groups in a well-balanced manner. Specifically, meat, fish, eggs, soy, and soy products in the first group are high in protein and produce muscles and blood. Milk, dairy products, seaweed, and small fish in the second group are rich in calcium and make bones and teeth. Green and yellow vegetables in the third group are rich in vitamins and minerals, protect the skin and mucous membranes, and regulate the functions of the body. Light-colored vegetables and fruits in the fourth group are rich in vitamins, minerals, and dietary fiber, regulate the functions of the body, and improve immunity. Cereals, potatoes, and sugars in the fifth group are high in carbohydrates, quickly turn into energy in the body, and regulate the functions of the body. Fats and oils and fat-rich foods in the sixth group are rich in fats and are a fatty energy source. The ice confections of the first embodiment are prepared to contain green-yellow vegetables, light-colored vegetables, and fruits, which are foods that tend to be insufficient in this nutritional food. Thus, the ice confection selecting means 113 and the flavoring material selecting means 114 perform an analysis from the viewpoint of nutritional management, and select an ice confection and a flavoring material so as to compensate for nutritional foods that are lacking for the customer.

In the mode (G) for inputting physical condition and constitution, the second information input means 112 inputs information on the customer relating to physical condition and constitution as question items, and the ice confection selecting means 113 and the flavoring material selecting means 114 select an ice confection and a flavoring material suitable for the customer according to this information. For example, if the customer is aware of having a cold constitution, an ice confection or a flavoring material containing ginger or the like is selected. Furthermore, for example, if the customer has a symptom of anemia, an ice confection or a flavoring material containing an ingredient with a large amount of iron, for example, prunes, is selected.

In the mode (H) for inputting food allergies, the second information input means 112 inputs information on a food allergy of the customer in response to questions about food allergies, and the ice confection selecting means 113 and the flavoring material selecting means 114 select, on the basis of this information, an ice confection and a flavoring material while avoiding ingredients having a problem with the customer's food allergy. The information input in the mode (H) for inputting food allergies is set as the highest priority item, and the ice confection selecting means 113 and the flavoring material selecting means 114 ensure that the ingredients having a problem with the customer's allergy are avoided.

In the mode (I) for inputting dietary restrictions, the second information input means 112 inputs information on a dietary restriction of the customer in response to questions about dietary restrictions, and the ice confection selecting means 113 and the flavoring material selecting means 114 select, on the basis of this information, an ice confection and a flavoring material in consideration of the dietary restriction of the customer. For example, when the GI value needs to be restricted, an ice confection containing a saccharide having a lower GI value than a predetermined GI value is selected. Furthermore, for example, when the calorie needs to be restricted, an ice confection having a lower calorie than a predetermined calorie value is selected. The information input in the mode (I) for inputting dietary restrictions is set as the highest priority item together with the information input in the mode (H), and the ice confection selecting means 113 and the flavoring material selecting means 114 select an ice confection and a flavoring material so as to ensure that the condition input in (I) is satisfied.

In the mode (J) for inputting questions about vitamins or minerals, the second information input means 112 grasps information on a vitamin or a mineral needed by the customer based on the questions about vitamins or minerals, and the ice confection selecting means 113 and the flavoring material selecting means 114 select, on the basis of this information, an ice confection and a flavoring material in consideration that the vitamin or mineral needed by the customer can be supplied. As the question items in the second information input means 112, questions corresponding to the effects of vitamins or minerals are employed. An ice confection and a flavoring material are selected, which contain, for example, vitamin B2 if the customer is worried about rough skin, vitamin E for stiff shoulders, calcium if the customer cannot take dairy products, or vitamins or minerals such as iodine for pregnant women.

In the mode (K) for inputting questions about phytochemicals, the second information input means 112 grasps information on a phytochemical needed by the customer based on questions about phytochemicals, and the ice confection selecting means 113 and the flavoring material selecting means 114 select, on the basis of this information, an ice confection and a flavoring material in consideration that the phytochemical needed by the customer can be supplied.

Phytochemicals are natural compounds present in plants. Vegetable foods contain nutrients such as vitamins and minerals and dietary fiber, and phytochemicals refer to components other than nutrients such as vitamins and minerals, which are color, aroma, bitterness, and the like. The five major nutrients in food are carbohydrates, proteins, lipids, vitamins, and minerals. In recent years, dietary fiber has attracted attention as the sixth nutrient, and it is said that phytochemicals are also attracting attention as the seventh nutrient.

As the question items in the second information input means 112, questions relating to phytochemicals are employed. According to Non-Patent Literature 1, for example, it is recommended to take foods such as: tomato containing lycopene, or paprika or capsicum containing capsanthin to prevent cancer and arteriosclerosis; green tea or persimmon containing catechin to adjust cholesterol; and berries such as blueberries containing anthocyanins to prevent vision loss due to aging.

In the mode (L) for inputting questions about dietary therapy, the second information input means 112 grasps information on the dietary therapy corresponding to the customer based on questions about dietary therapy, and the ice confection selecting means 113 and the flavoring material selecting means 114 select, on the basis of this information, an ice confection and a flavoring material needed by the customer from the viewpoint of the dietary therapy.

The treatment method to cure a disease by eating and drinking is called Ishoku Dogen in Oriental medicine, which means food is medicine, and it is said that it has been tried to be realized by the dietary therapy, that is, a cooking method combining cooking and Chinese medicine. The dietary therapy is also considered to be useful for creating a constitution that is less susceptible to diseases from the viewpoint of preventive medicine.

According to Non-Patent Literature 2, the dietary therapy adopts a dietary method that maintains health based on the idea of Oriental medicine's five tastes, five natures, and five seasons. Five tastes include sour, bitter, sweet, spicy, and salty. Sour is a sour taste, relating to qi and blood, bitter is a bitter taste, relating to heat and fluid, sweet is a sweet taste, relating to deficiency, qi and blood, and fluid, spicy is a spicy taste, relating to qi and blood, and salty is a salty taste, relating to excretion.

In addition, the five natures are classified as hot, warm, neutral, cool, and cold. For example, tomato harvested in summer is classified as the cold, having an effect of cooling the body. The five seasons mean seasons, taking the rainy season in addition to the four seasons into account.

In the mode (L), information on the customer is input in response to questions about the dietary therapy, and the ice confection selecting means 113 and the flavoring material selecting means 114 select, on the basis of this information, an ice confection and a flavoring material needed by the customer from the viewpoint of the dietary therapy.

In the mode (M) for inputting questions about Ayurveda, the second information input means 112 grasps information on Ayurveda corresponding to the customer based on questions about Ayurveda, and the ice confection selecting means 113 and the flavoring material selecting means 114 select, on the basis of this information, an ice confection and a flavoring material needed by the customer from the Ayurvedic point of view.

Ayurveda is a traditional medicine in the Indian continent such as India and Sri Lanka. It has been considered as a preventive medicine that grasps the state of mind and body, maintains a healthy state of mind and body, and prevents illness. According to Non-Patent Literature 3, food is considered to affect the physical and mental balance (for example, Vata (wind energy), Pitta (heat energy), Kapha (water energy) balance) in the same way as Ayurvedic drugs. The medicinal effects of food are determined by combining Lhasa (taste, taste target), Viruja (property), Guna (attribute), and Vipaka (taste after digestion). Lhasa is classified into the following six types: sweet, sour, salty, spicy, bitter, and astringent. Viruja is classified into the following three types: hot, cold, and neutral. Guna is classified into the following eight types: cold, hot, oily, dry, heavy, light, dull, and sharp, and further into the following 20 types: smooth, rough, solid, liquid, soft, hard, static, dynamic, fine, coarse, viscous, clear, and the above-described eight types. Vipaka is the result of the six types of Lhasa changed by digestion and is classified into the following three types: sweet, sour, and spicy. In the mode (M), the second information input means 112 grasps information on the physical and mental state of the customer based on questions about Ayurveda, and the ice confection selecting means 113 and the flavoring material selecting means 114 analyze this information, and select an ice confection and a flavoring material needed by the customer from the Ayurvedic point of view.

### [Third Information Output Means 115]

The third information on the ice confection and the flavoring material selected by the ice confection selecting means 113 and the flavoring material selecting means 114 is provided to the ice confection cutting means 122. In the third information output means 115, means of providing the ice confection cutting means 122 with the third information may be communication means by wired communications, wireless communications, or the like; data provision through a storage medium; provision through order slips or other paper media; provision through barcodes or two-dimensional barcodes; or data provision through display by display means.

The third information output means 115 can also provide the third information to the terminal 121. If the terminal 121 is a user's terminal, such as a smartphone, a tablet terminal, a mobile phone, or the like, the third information output means 115 preferably provides the third information to the terminal 121 through wireless communications. If the terminal 121 is a terminal provided in a store and this terminal 121 is a tablet terminal, for example, the third information output means 115 preferably provides the third information to the terminal 121 through wireless communications; and if this terminal is a personal computer, for example, the third information output means 115 preferably provides the third information to the terminal 121 through wired communications or wireless communications. The third information can be displayed on the terminal 121, whereby the third information is provided to the customer.

The third information provided by the third information output means 115 to the terminal 121 can further include, as the information on the selected ice confections or flavoring material, information on at least one of: names, types, effects, descriptions, medical knowledge, pharmaceutical knowledge, nutritional knowledge, therapeutic knowledge, reputation, word-of-mouth information, and Internet-based information of components, the flavor material, or the flavoring material of the ice confections. These pieces of the third information are displayed on the terminal 121 such that they correspond to modes (A) to (N), for example, in the second information input means 112.

In the tenth embodiment, an order is fixed at the time when the second information input means 112 first inputs the second information, but the present invention is not limited to this. For example, an order may be fixed after a customer acknowledges the third information transmitted to the terminal 121 from the third information output means 115. In this case, customers can fix an order after they check various information included in the third information and become satisfied, whereby higher customer satisfaction can be achieved. If customers are not satisfied with the third information they are checking, another second information can be input using the second information input means 112.

For the mode (A) to (E), it is desirable that at least the names, types, effects, and descriptions of components, flavor materials, or flavoring materials of each of the ice confections be displayed on the terminal 121 as the third information. As the effects, in particular, health-promoting effects of the flavor materials or the flavoring materials included in each of the ice confections can be displayed on the terminal 121. In the mode (A) in particular, it is desirable that reputation and word-of-mouth information be displayed on the terminal 121. Furthermore, Internet-based information on components, flavor materials, or flavoring materials of each of the ice confections can be provided. This enables customers to see an ice confection that satisfies their preferences is selected and fully understand advantages of the ice confection, so that they can further enjoy eating the shaved ice confection.

For the mode (F) or (G), it is desirable that the third information include at least information on foods and nutrients that should be supplemented for the customer, and their effects. For the mode (F), it is desirable that the third information also include nutritional analysis results. For the mode (G), it is desirable that the third information include information on physical condition and constitution improving effects of flavor materials or flavoring materials. In addition, reputation, word-of-mouth information, or Internet-based information of the flavor materials or the flavoring materials can also be provided. As a result, the customer can eat the selected ice confection to condition their mental and physical states and obtain satisfaction that the effect of improving their physical condition and constitution can be expected.

For the mode (H) or (I), it is desirable that the third information include at least information on foods and components excluded from the components of the ice confection based on the second information input by the customer. Furthermore, it is desirable that the third information include information such as GI value and calorie corresponding to the dietary restrictions on the components, flavor materials, or flavoring materials of each ice confection for the mode (I). Thus, the customer can confirm that allergy-provoking food is not contained or that conditions of dietary restrictions are satisfied, so that the customer can eat the shaved ice confection with confidence.

For the mode (J) or (K), it is desirable that the third information include at least information on nutritional knowledge, and the effects of vitamins, minerals, or phytochemicals. In addition, reputation, word-of-mouth information, or Internet-based information of the flavor material or the flavoring material can also be provided. As a result, the customer can learn that the selected ice confection can be expected to have a health-promoting effect and a physical condition/constitution improvement effect, and can increase satisfaction in eating the shaved ice confection.

For the mode (L) or (M), it is desirable that the third information include at least information on a diagnosis result from the viewpoint of the dietary therapy and Ayurveda, and foods and components that should be supplemented. It is also desirable to include medical, pharmaceutical, nutritional, and therapeutic knowledge. In particular, it is desirable that the third information include information on how the components, flavor materials, or flavoring materials of the selected ice confection contribute to improve the customer's physical condition, constitution, and physical and mental balance from the viewpoint of the dietary therapy or Ayurveda. This allows the customer to learn that the effects of improving the physical condition, constitution, and physical and mental balance can be expected from the ingredients and components contained in the shaved ice confection, thereby increasing satisfaction in eating the shaved ice confection.

For the mode (N), it is desirable that the third information include at least the registered names of the shaved ice confections consisting of an original combination selected by the customer, the names, types, effects, and descriptions of components, flavor materials, or flavoring materials of each of the ice confections. As a result, the customer can select their own original shaved ice confection and enjoy eating.

### [Ice Confection Cutting Means 122]

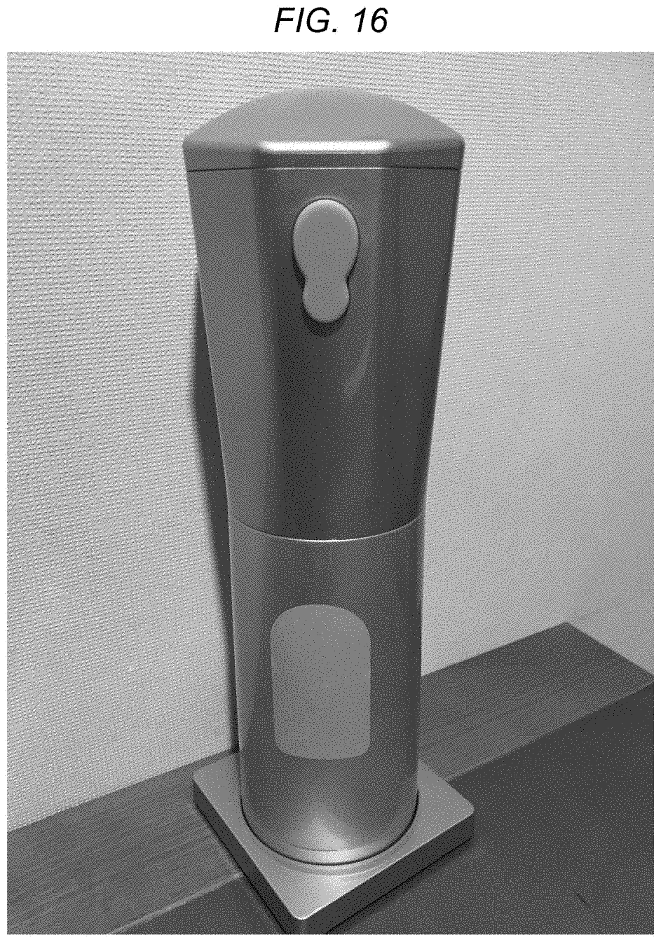

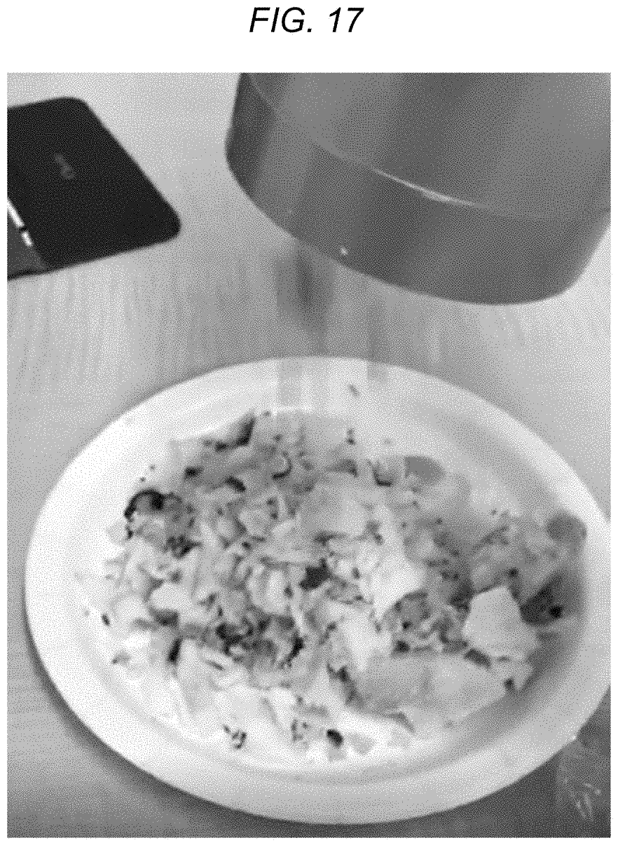

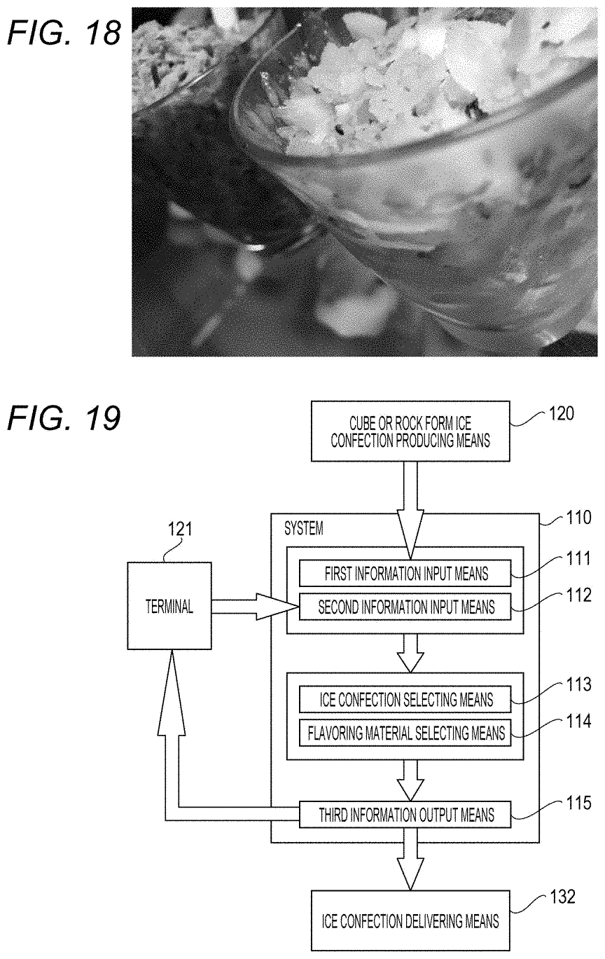

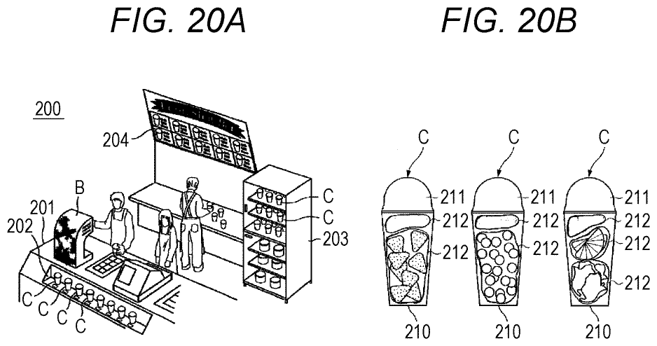

FIG. 16 illustrates an example rechargeable cordless hand-held ice shaver. FIG. 17 illustrates how an ice confection appears while it is being shaved using the ice shaver illustrated in FIG. 16. FIG. 18 illustrates an example shaved ice confection.

Based on the third information provided by the third information output means 115, the ice confection cutting means 122 shaves a selected number of selected cube form or rock form ice confections with an ice shaver. To shave the cube form or rock form ice confections, a compact ice shaver can be used. Examples of such a compact ice shaver include a manual or electrical ice shaver for household or commercial use, or a manual or electrical hand-held ice shaver. In particular, when the hand-held electrical ice shaver is used, a shaved ice confection can be easily made. In this context, by using a rechargeable or other cordless hand-held ice shaver in particular, the cube form or rock form ice confections can be shaved with the ice shaver in front of customers to provide a shaved ice confection. This can be an attractive performance in the store. Customers can see the ice confection they have chosen being shaved into a shaved ice confection in front of them, whereby higher customer satisfaction can be achieved.

The shaved ice confection can be served directly on a bowl. Examples of such bowl include a wafer bowl having a bottomed cylindrical shape or a bottomed rectangular columnar shape. A shaved ice confection served on a wafer bowl has good appearance, and can be eaten using a spoon or together with the wafer, in the latter case of which customers can enjoy different textures. Furthermore, the shaved ice confection can be sandwiched between two wafer bowls having a bottomed cylindrical shape or a bottomed rectangular columnar shape with their open edges in contact with each other.

The shaved ice confection can be sprinkled as a topping on the top of other food. For example, a shaved ice confection shaved with a hand-held ice shaver can be sprinkled directly on food such as pancakes and waffles.

To the shaved ice confection, the flavor material selected in the third information is added. Powdered material serving as the flavoring material is not limited to particular types. Examples of the material include alcohol (ethyl alcohol), vitamin preparations, dietary fibers, food flavors, spices, and seasonings. Furthermore, the flavoring material may be, for example, chocolate chip, granular nut, orange puree, fruit pulp, and other granular materials. The flavoring material may be added during the production steps for the ice confection, or sprinkled and added after the ice confection is shaved. In the case of sprinkling the flavoring material after the ice confection is shaved, by preparing a wide variety of flavor materials, such flavoring materials can be freely combined.

### Eleventh Embodiment

With reference to FIG. 19, a method for producing a shaved ice confection according to an eleventh embodiment will be described. The eleventh embodiment provides a method for producing a shaved ice confection at home or the like, and the parts of FIG. 19 that are the same as those in the tenth embodiment are denoted by the same reference signs, and a detailed description therefor is omitted.

In the eleventh embodiment, a customer inputs second information on an ice confection and/or a flavoring material suitable for the customer, through the terminal 121 by the second information input means 112. The second information includes delivery address information as the customer's personal information. The terminal 121 is the customer's smartphone, tablet terminal, personal computer, mobile phone, or the like. Using the terminal 121, the customer remotely places an order of the cube form or rock form ice confection and/or the flavoring material. In this case, the second information input means 112 may operate on a browser or operate as an application downloaded to the terminal 121, for example.

When the order is fixed and the ice confection selecting means 113 and/or the flavoring material selecting means 114 select(s) the ice confection and/or the flavoring material, the third information output means 115 provides the ice confection delivering means 132 with third information on the cube form or rock form ice confection and/or the flavoring material. The third information includes delivery address information included in the information for identifying an individual input through the terminal 121 to the second information input means 112. In the third information output means 115, means of providing the ice confection delivering means 132 with the third information may be communication means by wired communications, wireless communications, or the like; data provision through a storage medium; provision through order slips or other paper media; provision through barcodes or two-dimensional barcodes; or data provision through display by display means.

The ice confection delivering means 132 delivers the selected cube form or rock form ice confection and/or flavoring material to the specified delivery address, for example, the customer's home or the like, in accordance with the delivery address information included in customer's information for identifying an individual added to the third information.

Upon receiving a delivery order from a customer for the first time, the ice confection delivering means 132 delivers an ice shaver, for example, a rechargeable cordless hand-held ice shaver, together with the selected cube form or rock form ice confection and/or flavoring material to the specified delivery address.

It is desirable that the third information output means 115 provide the ice confection delivering means 132 with the third information on the cube form or rock form ice confection and/or the flavoring material after an order is fixed. An order may be fixed at the time when the second information input means 112 first inputs the second information, but the present invention is not limited to this. For example, an order may be fixed after a customer acknowledges the third information transmitted to the terminal 121 from the third information output means 115. In this case, customers can fix an order after they check various information included in the third information and become satisfied, whereby higher customer satisfaction can be achieved. If customers are not satisfied with the third information they are checking, another second information can be input by the second information input means 112.

After receiving the delivered cube form or rock form ice confection and/or flavoring material, the customer can produce a shaved ice confection at home or the like that is the delivery address, using the hand-held ice shaver delivered at the first order. Since the delivered cube form or rock form ice confection can be stored in a home refrigerator, the customer can easily make an original shaved ice confection suitable for the customer anytime, with the cube form or rock form ice confection stored in the home refrigerator using the hand-held ice shaver.

The number of cube form or rock form ice confections to be ordered can be set optionally. For example, a set of 6, 12, and so on are freely selected. In addition, cube form or rock form ice confections of different food tastes and textures can be ordered and delivered at the same time.

The customer can order wafer bowls together with ice confections. Furthermore, the hand-held ice shaver can be additionally ordered. While the eleventh embodiment uses the hand-held ice shaver delivered in advance to produce a shaved ice confection at home or the like, the present invention is not limited to this. For example, a manual or electrical ice shaver for household use can be used to produce a shaved ice confection. It should be noted that the length of blades in the hand-held ice shaver can be adjusted or an attachment equipped with blades can be replaced in order to adjust the thickness or the like of the shaved ice confection. This can adjust the texture of the shaved ice confection while using the same cube form or rock form ice confection.

While it is assumed that the customer specifies the customer's home or the like as the address of delivery in the eleventh embodiment, the present invention is not limited to this. For example, the customer can specify a specific store and reserve an ice confection. For some stores, the types of cube form or rock form ice confections and the types of flavor materials available may be somewhat different. To have an ideal ice confection served at a specific store without fail, the customer can make a reservation with the store using specific second information.

While it is assumed that the shaved ice confection is eaten as it is in the tenth and the eleventh embodiments, the present invention is not limited to this. For example, this shaved ice confection can be frozen again in a low-temperature refrigerator. When the shaved ice confection frozen again in a low-temperature refrigerator is put in the mouth, the following three types of textures can be enjoyed:

(1) a crispy rice cracker-like texture that gives hard crunchiness,

(2) a texture softening in the mouth, and

(3) a texture providing unique thickened feeling as the confection dissolves in about three seconds in the mouth.

### REFERENCE SIGNS LIST

11 cutting step
12 superheated steam sterilization step
13 crushing step
14 first aqueous solution preparation step
15 second aqueous solution preparation step
16 in-mold injection step
17 refrigerating step
20 planetary centrifugal mixer
21 rotary member
22 spin direction
23 revolution direction
30, 30A refrigerator
31 rectangular container
32 heat exchanger
33 cooling medium (refrigerant)
34 conduit
35 liquefied nitrogen
36 outlet end
37, 38, 40 conduit
39 circulation pump
41 inlet end
45 popsicle mold
46 second aqueous solution
47 holding stick
50 packed drink production step
51 puree or paste preparation step
51a cutting step
51b superheated steam sterilization step
51c crushing step
52 ingredient selecting step on a customer's order
52a select a drink in a container
52b select an ice confection
53 airtight-container filling and sealing step
54 refrigerating step
55 ice confection producing method selecting step
60 packed drink producing system
61 first information input means
62 second information input means
63 information input means
64 customer preference analyzing means
65 third information output means
66 drink, puree, or paste producing means
67 terminal
68 packed drink or ice confection producing means
70, 70A packed drink
71, 71A airtight container
72 lip
73 cap
75 label

1. A method for producing puree or paste of an ingredient, the method comprising steps (1) to (3):
(1) cutting an ingredient into a certain size when the ingredient is at least as large as a size predetermined for the ingredient;
(2) performing heat sterilization for a certain period of time in a low oxygen state in a superheated steam atmosphere at a certain temperature; and
(3) processing the ingredient into a puree or paste form using any one of a planetary centrifugal mixer, a millstone grinder, and a rotary cutter mixer, depending on a type of the ingredient or a finished state of the puree or paste.

2. The method for producing puree or paste of an ingredient according to claim 1, wherein in step (1), the ingredient is any one of fruits, vegetables, beans, nuts and seeds, and grains.

3. The method for producing puree or paste of an ingredient according to claim 1, wherein in step (1), a plurality of rotary round blades are used for cutting the ingredient into a certain size.

4. The method for producing puree or paste of an ingredient according to claim 1, wherein in step (2), with use of superheated steam at 100° C. to 280° C., the heat sterilization is performed for a duration of 1 minute to 60 minutes.

5. The method for producing puree or paste of an ingredient according to claim 1, wherein in step (3), depending on the type of the ingredient or the finished state of the puree or paste, any means of the planetary centrifugal mixer, the millstone grinder, or the rotary cutter mixer is selected, and settings for the selected means are adjustable.

6. A method for producing an ice confection that uses at least one type of drink selected from a drink made of the puree or paste of the ingredient produced by the method for producing puree or paste of an ingredient according to claim 1 and a drink containing a flavor material, the method comprising steps (4) to (6):
(4) preparing a second aqueous solution by adding a stabilizer to the selected drink;
(5) injecting the second aqueous solution into a mold having a certain shape; and
(6) refrigerating and freezing the second aqueous solution injected into the mold by circulating a refrigerant around the mold.

7. The method for producing an ice confection according to claim 6, wherein step (4) includes steps of:
(4-1) preparing a first aqueous solution obtained by dissolving a stabilizer in water or warm water; and
(4-2) preparing the second aqueous solution by adding the selected drink to the first aqueous solution.

8. The method for producing an ice confection according to claim 6, wherein step (4) includes a thawing step when the drink made of the puree or paste of the ingredient produced by the method for producing puree or paste of an ingredient or the drink containing a flavor material is frozen.

9. A method for producing an ice confection that uses at least one type of drink selected from a drink made of the puree or paste of the ingredient produced by the method for producing puree or paste of an ingredient according to claim 1 and a drink containing a flavor material, the method comprising steps (4a) and (5a):
(4a) preparing a second aqueous solution by adding a stabilizer to the selected drink; and
(5a) putting air into an ice confection by stirring and cooling the second aqueous solution.

10. The method for producing an ice confection according to claim 9, wherein step (4a) includes steps of:
(4a-1) preparing a first aqueous solution obtained by dissolving a stabilizer in water or warm water; and
(4a-2) preparing the second aqueous solution by adding the selected drink to the first aqueous solution.

11. The method for producing an ice confection according to claim 9, wherein step (4a) includes a thawing step when the drink made of the puree or paste of the ingredient produced by the method for producing puree or paste of an ingredient or the drink containing a flavor material is frozen.

12. The method for producing an ice confection according to claim 9, wherein the ice confection has an overrun of 60% to 300% inclusive.

13. The method for producing an ice confection according to claim 9, wherein the ice confection obtained in step (5a) is provided in at least one form selected from a soft-serve ice cream form, a popsicle form, an ice cream cup form, a wafer ice cream form, and a shaved ice form.

14. The method for producing an ice confection according to claim 9, further comprising a step of (6a) placing the ice confection obtained in step (5a) in an ice cream container, a cup, or a container representing an ingredient shape.

15. The method for producing an ice confection according to claim 6, wherein the stabilizer is any one of kudzu starch, kudzu powder, lotus root powder, rice flour, brown rice flour, bracken starch, potato flour, agar, and gelatin or a combination of two or more of these.

16. The method for producing an ice confection according to claim 15, wherein the stabilizer is finely ground.

17. The method for producing an ice confection according to claim 6, wherein in step (4) or (4a), at least one selected from the group consisting of:
(a) a sweetener made of wasanbon, agave syrup, brown sugar, maple syrup, or non-centrifugal sugar,
(b) a flavoring material made of an alcohol, a vitamin preparation, a dietary fiber, a food flavor, a spice, or a seasoning, and
(c) a powdered material
or a combination of two or more of these is further added.

18. A system for producing puree or paste of an ingredient adopting the method for producing puree or paste of an ingredient according to claim 1.

19. The system for producing puree or paste of an ingredient according to claim 18, wherein the system for producing puree or paste includes container-shaped units and the units are stackable.

20. Puree or paste of an ingredient produced by the method for producing puree or paste of an ingredient according to claim 1.

21. A system for producing an ice confection adopting the method for producing an ice confection according to claim 6.

22. The system for producing an ice confection according to claim 21, wherein the system for producing an ice confection includes container-shaped units and the units are stackable.

23. An ice confection produced by the method for producing an ice confection according to claim 6.

24. A method for producing a drink in an airtight container on demand by a customer's order, the method using at least one type of drink selected from a drink made of the puree or paste of the ingredient produced by the method for producing puree or paste of an ingredient according to claim 1 and a drink containing a flavor material, the method comprising steps (1b) to (4b):
(1b) preparing drinks, purees, or pastes of various types of ingredients in advance;
(2b) selecting at least one of the drinks, purees, or pastes of the ingredients that fulfills the customer's order;
(3b) filling and sealing the drink, puree, or paste of the selected ingredient in an airtight container; and
(4b) cooling the airtight container filled with the drink, puree, or paste of the ingredient in a refrigerator maintained at a certain temperature for a certain period of time such that the drink, puree, or paste of the ingredient becomes a state that fulfills the customer's order.

25. The method for producing a drink in an airtight container on demand by a customer's order according to claim 24, wherein a refrigerator including a box in which a cooled refrigerant is circulated is used as the refrigerator maintained at the certain temperature, and the airtight container filled with the ingredient is immersed in the refrigerant in the box.

26. The method for producing a drink in an airtight container on demand by a customer's order according to claim 24, wherein a temperature and/or a duration for cooling the drink, puree, or paste of the ingredient are/is set in accordance with the customer's order.

27. The method for producing a drink in an airtight container on demand by a customer's order according to claim 24, wherein to the drink, puree, or paste of the ingredient that fulfills the customer's order, at least one selected from a sweetener of a type and/or an amount selected in accordance with the customer's order, a topping ingredient selected in accordance with the customer's order, and a food additive selected in accordance with the customer's order is added.

28. A system for producing a drink in an airtight container on demand by a customer's order, the system using at least one type of drink selected from a drink made of the puree or paste of the ingredient produced by the method for producing puree or paste of an ingredient according to claim 1 and a drink containing a flavor material, the system comprising steps (1c) to (3c):
(1c) selecting a drink, puree, or paste of an ingredient that fulfills the customer's order from among drinks, purees, or pastes of various types of ingredients;
(2c) filling and sealing the drink, puree, or paste of the selected ingredient in an airtight container; and
(3c) cooling the airtight container filled with the drink, puree, or paste of the ingredient in a refrigerator maintained at a certain temperature for a certain period of time such that the drink, puree, or paste of the ingredient becomes a state that fulfills the customer's order.

29. A system for producing a drink in an airtight container on demand by a customer's order, the system using at least one type of drink selected from a drink made of the puree or paste of the ingredient produced by the method for producing puree or paste of an ingredient according to claim 1 and a drink containing a flavor material, the system comprising means (a) to (c):
(a) means of inputting information on drinks, purees, or pastes of various types of ingredients prepared in advance as first information;
(b) means of inputting second information from a terminal, analyzing preference of food tastes and a degree of cooling or refrigerating by using the first information and the second information, selecting a certain amount of at least one drink, puree, or paste selected from among the drinks, purees, or pastes of the various types of ingredients input as the first information, and setting a temperature and/or a duration for cooling in a refrigerator; and
(c) means of outputting third information on the temperature and/or the duration for cooling in the refrigerator and the drink, puree, or paste selected in means (b) as information on the drink, puree, or paste to be filled in an airtight container and cooled.

30. The system for producing a drink in an airtight container on demand by a customer's order according to claim 29, wherein means (b) performs at least one selected from the group consisting of:
(b-1) setting the temperature and/or the duration for cooling the drink, puree, or paste of the ingredient in accordance with the customer's order; and
(b-2) based on the second information, determining at least one selected from a type and/or an amount of a sweetener to be added to an ice confection, a food additive to be added to the ice confection, and a topping ingredient to be added to the ice confection.

31. A program for producing a drink in an airtight container on demand by a customer's order, causing a computer to operate as the means in the system for producing a drink in an airtight container on demand by a customer's order according to claim 29.

32. A storage medium storing the program for producing a drink in an airtight container on demand by a customer's order according to claim 31.

33. A drink in an airtight container on demand by a customer's order, wherein a drink, puree, or paste of an ingredient according to a customer choice is filled and sealed in an airtight container,
the puree or paste is produced by the method for producing puree or paste of an ingredient according to claim 1, and
the airtight container filled with the drink, puree, or paste of the ingredient is cooled such that the drink, puree, or paste of the ingredient becomes a cooled state or frozen state that fulfills the customer's order.

34. The drink in an airtight container on demand by a customer's order according to claim 33, wherein to the drink, puree, or paste of the ingredient, at least one selected from a sweetener of a type and/or an amount selected in accordance with the customer's order, a topping ingredient selected in accordance with the customer's order, and a food additive selected in accordance with the customer's order is added.

35. The drink in an airtight container on demand by a customer's order according to claim 33, wherein the airtight container is provided with a capped lip.

36. The drink in an airtight container on demand by a customer's order according to claim 33, wherein a label is attached to a surface of the airtight container, and a straw is storable in a space between the surface of the airtight container and the label.

37. A method for producing an ice confection on demand by a customer's order, the method using at least one type of drink selected from a drink made of the puree or paste of the ingredient produced by the method for producing puree or paste of an ingredient according to claim 1 and a drink containing a flavor material, the method comprising steps (1d) to (4d):
(1d) preparing drinks, purees, or pastes of various types of ingredients in advance;
(2d) selecting at least one each of a stabilizer, a sweetener, and a drink, puree, or paste of an ingredient that fulfill the customer's order;
(3d) producing an ice confection from the ingredient selected in step (2d) or selecting an ice confection produced in advance; and
(4d) providing the ice confection obtained in step (3d) in a form that fulfills the customer's order.

38. The method for producing an ice confection on demand by a customer's order according to claim 37, further comprising
a step of (5d) attaching at least one of an arrangement, a pattern, a message, an illustration, a photograph, and an image that fulfill the customer's order, using a topping ingredient, to the ice confection.

39. A system for producing an ice confection on demand by a customer's order, the system using at least one type of drink selected from a drink made of the puree or paste of the ingredient produced by the method for producing puree or paste of an ingredient according to claim 1 and a drink containing a flavor material, the system comprising steps (1e) to (3e):
(1e) selecting at least one each of a stabilizer, a sweetener, and a drink, puree, or paste of an ingredient that fulfill the customer's order;
(2e) producing an ice confection from the ingredient selected in step (1e) or selecting an ice confection produced in advance; and
(3e) providing the ice confection obtained in step (2e) in a form that fulfills the customer's order.

40. A system for producing an ice confection on demand by a customer's order, the system using at least one type of drink selected from a drink made of the puree or paste of the ingredient produced by the method for producing puree or paste of an ingredient according to claim 1 and a drink containing a flavor material, the system comprising means (a) to (c):
(a) means of inputting information on drinks, purees, or pastes of various types of ingredients prepared in advance and information on various types of stabilizers as first information;
(b) means of inputting second information from a terminal, analyzing preference of food tastes and a degree of cooling or refrigerating by using the first information and the second information, setting at least one drink selected from among the drinks, purees, or pastes of the various types of ingredients input as the first information, and setting at least one stabilizer selected from among the various types of stabilizers input as the first information; and
(c) means of outputting third information that is information on the selected drink, puree, or paste and the selected stabilizer.

41. The system for producing a drink in an airtight container on demand by a customer's order according to claim 40, wherein means (b) performs at least one selected from the group consisting of:
(b-1) determining at least one selected from a sweetener of a type and/or an amount selected in accordance with the customer's order, a topping ingredient selected in accordance with the customer's order, and a food additive selected in accordance with the customer's order;
(b-2) based on the second information, determining at least one selected from the type and/or the amount of the sweetener to be added to the ice confection, a food additive to be added to the ice confection, and a topping ingredient to be added to the ice confection; and
(b-3) based on the second information, determining a form of the ice confection that fulfills the customer's order.

42. A program for producing an ice confection on demand by a customer's order, causing a computer to operate as the means in the system for producing an ice confection on demand by a customer's order according to claim 40.

43. A storage medium storing therein the program for producing an ice confection on demand by a customer's order according to claim 42.

44. A method for producing a shaved ice confection, the method comprising steps of:
(1f) preparing a plurality of types of cube form or rock form ice confections provided with respective food tastes, the ice confections being produced by adding at least one type of drink selected from a drink made of the puree or paste of the ingredient produced by the method for producing puree or paste of an ingredient according to claim 1 and a drink containing a flavor material;
(2f) inputting information on the cube form or rock form ice confections provided with respective food tastes prepared in step (1f) as first information;
(3f) inputting second information from a terminal, analyzing preference of food tastes and/or required food or components by using the first information and the second information, and outputting third information on a certain number of cube form or rock form ice confections selected from among the cube form or rock form ice confections provided with respective food tastes input as the first information; and
(4f) shaving the cube form or rock form ice confections selected based on the third information output in step (3f) with an ice shaver.

45. The method for producing a shaved ice confection according to claim 44, wherein a stabilizer used in the cube form or rock form ice confections is any one of kudzu starch, kudzu powder, lotus root powder, rice flour, bracken starch, potato flour, agar, and gelatin or a combination of two or more of these in step (1f).

46. The method for producing a shaved ice confection according to claim 44, wherein the second information input in step (3f) includes information on at least one of:
(a) flavor material type,
(b) food taste preference,
(c) texture preference,
(d) degree of sweetness,
(e) degree of sourness,
(f) spice preference,
(g) favorite food,
(h) least favorite food,
(i) menu of a meal,
(j) body shape,
(k) constitution,
(l) physical condition,
(m) diseases,
(n) dietary restriction,
(o) allergy-provoking food, and
(p) information for identifying an individual.

47. The method for producing a shaved ice confection according to claim 44, wherein the second information is input through the terminal interactively in step (3f).

48. The method for producing a shaved ice confection according to claim 44, wherein the second information is capable of being input remotely through the terminal in step (3f).

49. The method for producing a shaved ice confection according to claim 44, wherein the third information further includes information on a selected flavoring material in step (3f), and adding the flavoring material to the ice confections based on the information on the flavoring material included in the third information in step (4f).

50. The method for producing a shaved ice confection according to claim 44, wherein in step (3f), the third information includes, as the information on the selected ice confections or flavoring material, information on at least one of: names, types, effects, descriptions, medical knowledge, pharmaceutical knowledge, nutritional knowledge, therapeutic knowledge, reputation, word-of-mouth information, and Internet-based information of components, the flavor material, or the flavoring material of the ice confections, and the third information is displayable on the terminal.

51. The method for producing a shaved ice confection according to claim 44, wherein the cube form or rock form ice confections is shaved with a hand-held ice shaver in step (4f).

52. A system for producing a shaved ice confection, the system comprising means of:
(1g) inputting, as first information, information on a plurality of types of cube form or rock form ice confections provided with respective food tastes, the ice confections being produced by adding at least one type of drink selected from a drink made of the puree or paste of the ingredient produced by the method for producing puree or paste of an ingredient according to claim 1 and a drink containing a flavor material;
(2g) inputting second information from a terminal, analyzing preference of food tastes and/or required food or components by using the first information and the second information, and selecting a certain number of cube form or rock form ice confections from among the cube form or rock form ice confections provided with respective food tastes input as the first information; and
(3g) outputting, as information on cube form or rock form ice confections to be put altogether into and cut with an ice shaver, third information on the cube form or rock form ice confections selected in means (2g).

53. The system for producing a shaved ice confection according to claim 52, wherein a stabilizer used in the cube form or rock form ice confections is any one of kudzu starch, kudzu powder, lotus root powder, rice flour, bracken starch, potato flour, agar, and gelatin or a combination of two or more of these in means (1g).

54. The system for producing a shaved ice confection according to claim 52, wherein the second information input in means (2g) includes information on at least one of:
(a) flavor material type,
(b) food taste preference,
(c) a texture preference,
(d) degree of sweetness,
(e) degree of sourness,
(f) spice preference,
(g) favorite food,
(h) least favorite food,
(i) menu of a meal,
(j) body shape,
(k) constitution,
(l) physical condition,
(m) diseases,
(n) dietary restriction,
(o) allergy-provoking food, and
(p) information for identifying an individual.

55. The system for producing a shaved ice confection according to claim 52, wherein the second information is input through the terminal interactively in means (2g).

56. The system for producing a shaved ice confection according to claim 52, wherein the second information is capable of being input remotely through the terminal in means (2g).

57. The system for producing a shaved ice confection according to claim 52, wherein a flavoring material to be further added to the shaved ice confections is selected in means (2g), and the third information includes information on the flavoring material in means (3g).

58. The system for producing a shaved ice confection according to claim 52, wherein in means (3g), the third information includes, as the information on the selected ice confections or flavoring material, information on at least one of: names, types, effects, descriptions, medical knowledge, pharmaceutical knowledge, nutritional knowledge, therapeutic knowledge, reputation, word-of-mouth information, and Internet-based information of components, the flavor material, or the flavoring material of the ice confections, and the third information is displayable on the terminal.

59. The system for producing a shaved ice confection according to claim 52, wherein the third information includes information on the cube form or rock form ice confections shaved with a hand-held ice shaver in means (3g).

60. The system for producing a shaved ice confection according to claim 52, wherein the third information further includes information for delivering the selected cube form or rock form ice confections in means (3g).

61. A program for producing a shaved ice confection, causing a computer to operate as the means in the system for producing a shaved ice confection according to claim 52.

62. A storage medium storing therein the program according to claim 61.
